(19) United States
(12) Patent Application Publication
(10) Pub. No.: US 2024/0031090 A1
(43) Pub. Date: Jan. 25, 2024

(54) GRANT-FREE NOMA COMMUNICATION IN SIDELINK

(71) Applicant: QUALCOMM Incorporated, San Diego, CA (US)

(72) Inventors: Ahmed ELSHAFIE, San Diego, CA (US); Seyedkianoush HOSSEINI, San Diego, CA (US); Wei YANG, San Diego, CA (US)

(21) Appl. No.: 17/814,498

(22) Filed: Jul. 22, 2022

(51) Int. Cl. H04L 5/00

(52) U.S. Cl. CPC H04L 5/0048; H04L 5/0098

(57) ABSTRACT

A UE may be configured to obtain at least one configuration of a set of RPs from a network node, the set of RPs being associated with grant-free NOMA for sidelink communication, and transmit a sidelink transmission via a sidelink channel to at least one other UE in the set of RPs associated with the grant-free NOMA based on the at least one configuration of the set of RPs. The at least one configuration of a set of RPs may include at least one of a power configuration, a DMRS configuration, or a set of FD-OCC associated with a PSCCH, and an oversampling factor is applied to the set of FD-OCC.

### TECHNICAL FIELD

The present disclosure relates generally to communication systems, and more particularly, to a method of sidelink communication including a grant-free non-orthogonal multiple access (NOMA) communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR) and 6G. 5G NR and 6G are part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), ultra-reliable low latency communications (URLLC), and massive connectivity. Some aspects of 5G NR and 6G may be based on the 4G Long Term Evolution (LTE) standard. There exists a need for further improvements in 5G NR and 6G technology.

These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a transmission (Tx) user equipment (UE), configured to obtain at least one configuration of a set of resource pools (RPs) from a network node, the set of RPs being associated with grant-free NOMA for sidelink communication, and transmit a sidelink transmission via a sidelink channel to at least one other UE in the set of RPs associated with the grant-free NOMA based on the at least one configuration of the set of RPs.

In an aspect of the disclosure, a method, a computer-readable medium, and an apparatus are provided. The apparatus may be network node configured to transmit at least one configuration of a set of RPs for a plurality of UEs including a first UE and a second UE, the set of RPs being associated with grant-free NOMA for sidelink communication between the plurality of UEs, and transmit an instruction to activate or deactivate the NOMA for the sidelink communication for the plurality of UEs, where a sidelink transmission is communicated between the first UE and the second UE via a sidelink channel in the set of RPs associated with the grant-free NOMA based on the at least one configuration of the sidelink channel.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2 illustrates example aspects of a sidelink (SL) slot structure.

FIG. 3 is a diagram illustrating an example of a base station and user equipment (UE) in an access network.

FIG. 4 is a diagram illustrating SL resource reservation in sidelink communication.

FIG. 5 is an example of assigning physical sidelink feedback channel (PSFCH) resources in sidelink communication.

FIG. 6 is an example of assigning PSFCH resources in sidelink communication.

FIG. 7 is a diagram illustrating SL resource reservation in sidelink communication.

FIG. 8 is an example of assigning PSFCH resources in sidelink communication.

FIG. 9 is a call-flow diagram of a method of wireless communication

FIG. 10 is a flowchart of a method of wireless communication.

FIG. 11 is a flowchart of a method of wireless communication.

FIG. 12 is a flowchart of a method of wireless communication.

FIG. 13 is a flowchart of a method of wireless communication.

FIG. 14 is a call-flow diagram of a method of wireless communication

FIG. 15 is a flowchart of a method of wireless communication.

FIG. 16 is a flowchart of a method of wireless communication.

FIG. 17 is a flowchart of a method of wireless communication.

FIG. 18 is a flowchart of a method of wireless communication.

FIG. 19 is a diagram illustrating an example of a hardware implementation for an example apparatus and/or network entity.

FIG. 20 is a diagram illustrating an example of a hardware implementation for an example network entity.

### DETAILED DESCRIPTION

For massive connectivity scenarios such as sidelink IoT set up, grant-free non-orthogonal multiple access (NOMA) configurations may provide reduced network latency, reduced signaling overhead, and network resource efficiency. To provide the grant-free NOMA configuration, the network node may send configuration of a set of resource pools (RPs) for a user equipment (UE) to perform the grant-free NOMA operation. Here, the at least one configuration of a set of RPs may provide various ways for the UEs (e.g., the Tx UE or the reception (Rx) UE) to separate the sidelink signals and perform interference cancellation.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

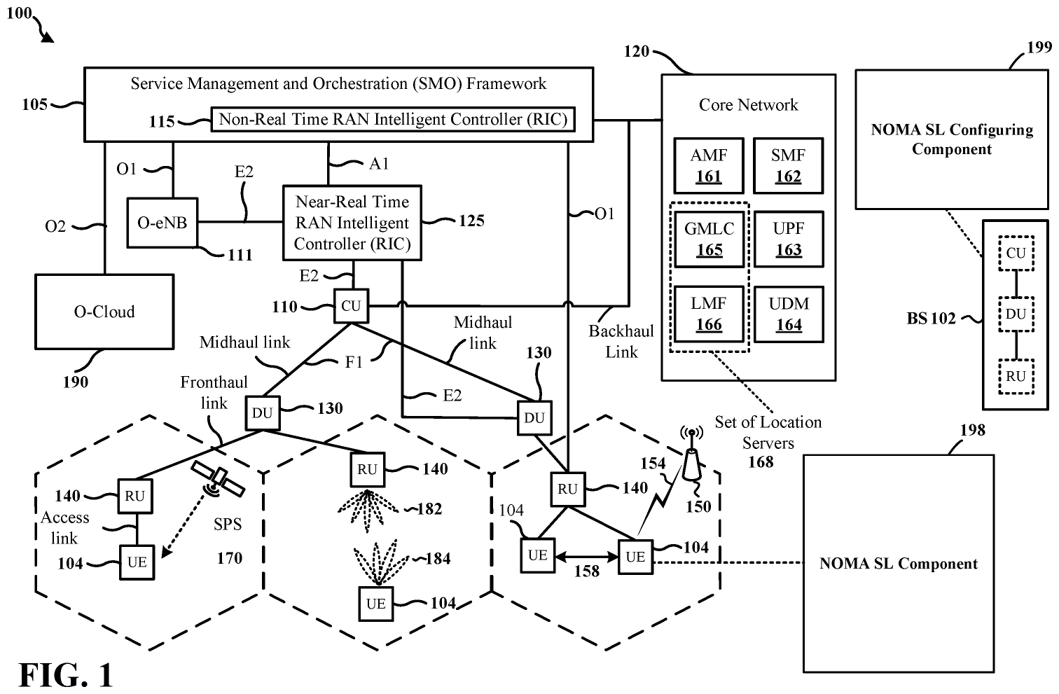

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell). Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a NOMA SL component 198 configured to obtain at least one configuration of a set of RPs from a network node, the set of RPs being associated with grant-free NOMA for sidelink communication, and transmit a sidelink transmission via a sidelink channel to at least one other UE in the set of RPs associated with the grant-free NOMA based on the at least one configuration of the set of RPs. In certain aspects, the base station 102 may include a NOMA SL configuring component 199 configured to transmit at least one configuration of a set of RPs for a plurality of UEs including a first UE and a second UE, the set of RPs being associated with grant-free NOMA for sidelink communication between the plurality of UEs, and transmit an instruction to activate or deactivate the NOMA for the sidelink communication for the plurality of UEs, where a sidelink transmission is communicated between the first UE and the second UE via a sidelink channel in the set of RPs associated with the grant-free NOMA based on the at least one configuration of the sidelink channel. Although the following description may be focused on 5G NR or 6G, the concepts described herein may be applicable to other similar areas, such as LTE, LTE-A, CDMA, GSM, and other wireless technologies.

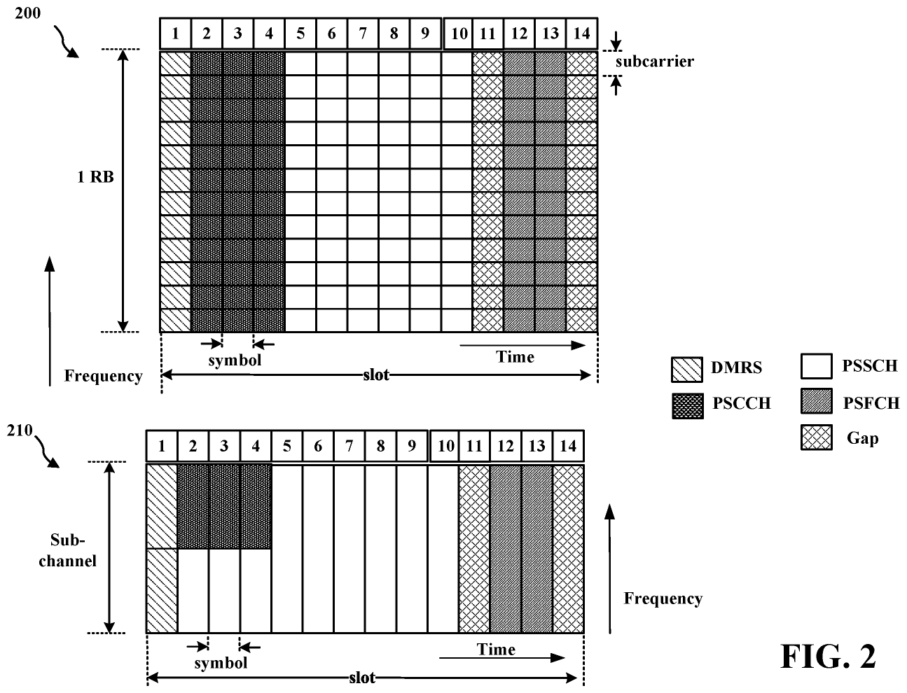

FIG. 2 includes diagrams 200 and 210 illustrating example aspects of slot structures that may be used for sidelink communication (e.g., between UEs 104, RSU 107, etc.). The slot structure may be within a 5G/NR frame structure in some examples. In other examples, the slot structure may be within an LTE frame structure. Although the following description may be focused on 5G NR, the concepts described herein may be applicable to other similar areas, such as LTE, LTE-A, CDMA, GSM, and other wireless technologies. The example slot structure in FIG. 2 is merely one example, and other sidelink communication may have a different frame structure and/or different channels for sidelink communication. A frame (10 ms) may be divided into equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. Diagram 200 illustrates a single resource block of a single slot transmission, e.g., which may correspond to a 0.5 ms transmission time interval (TTI). A physical sidelink control channel may be configured to occupy multiple physical resource blocks (PRBs), e.g., 10, 12, 15, 20, or 25 PRBs. The PSCCH may be limited to a single sub-channel. A PSCCH duration may be configured to be 2 symbols or 3 symbols, for example. A sub-channel may comprise 10, 15, 20, 25, 50, or 100 PRBs, for example. The resources for a sidelink transmission may be selected from a resource pool including one or more subchannels. As a non-limiting example, the resource pool may include between 1-27 subchannels. A PSCCH size may be established for a resource pool, e.g., as between 10-100% of one subchannel for a duration of 2 symbols or 3 symbols. The diagram 210 in FIG. 2 illustrates an example in which the PSCCH occupies about 50% of a subchannel, as one example to illustrate the concept of PSCCH occupying a portion of a subchannel. The physical sidelink shared channel (PSSCH) occupies at least one subchannel. The PSCCH may include a first portion of sidelink control information (SCI), and the PSSCH may include a second portion of SCI in some examples.

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 2, some of the REs may comprise control information in PSCCH and some Res may comprise demodulation RS (DMRS). At least one symbol may be used for feedback. FIG. 2 illustrates examples with two symbols for a physical sidelink feedback channel (PSFCH) with adjacent gap symbols. A symbol prior to and/or after the feedback may be used for turnaround between reception of data and transmission of the feedback. The gap enables a device to switch from operating as a transmitting device to prepare to operate as a receiving device, e.g., in the following slot. Data may be transmitted in the remaining REs, as illustrated. The data may comprise the data message described herein. The position of any of the data, DMRS, SCI, feedback, gap symbols, and/or LBT symbols may be different than the example illustrated in FIG. 2. Multiple slots may be aggregated together in some aspects.

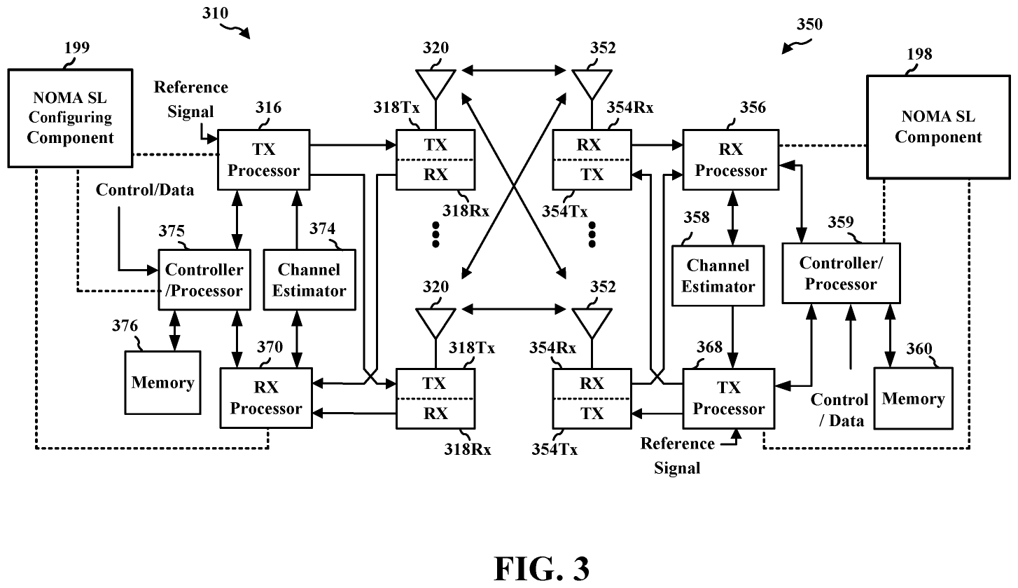

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting, PDCP layer functionality associated with header compression/decompression, security (ciphering, deciphering, integrity protection, integrity verification), and handover support functions, RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs, and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (Tx) processor 316 and the receive (Rx) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an acknowledgement (ACK) and/or negative acknowledgement (NACK) protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting, PDCP layer functionality associated with header compression/decompression, and security (ciphering, deciphering, integrity protection, integrity verification), RLC layer functionality associated with the transfer of upper layer PDUs, error correction through ARQ, concatenation, segmentation, and reassembly of RLC SDUs, re-segmentation of RLC data PDUs, and reordering of RLC data PDUs, and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the NOMA SL component 198 of FIG. 1. At least one of the TX processor 316, the RX processor 370, and the controller/processor 375 may be configured to perform aspects in connection with the NOMA SL configuring component 199 of FIG. 1.

A network node may configure or schedule grant for a UE to transmit uplink (UL) data transmission. Based on the grant-based UL transmission, the network node may reduce the risk of collision of the UL transmission from the UE with other signals (e.g., other UL signals from other UEs, DL signals from other network node, or DL signals of the network node) or cancel the interferences caused by the other signals. In some aspects, a massive connectivity may be provided for a relatively larger number of UEs within a unit area. For example, a massive connectivity may be provided for IoT devices (e.g., industrial sensors, utility meters, in-home networks, wearable devices, asset trackers, hearth monitors, video surveillance devices, etc.), and the massive connectivity may provide connection for a relatively increased connection density (e.g., 10 million devices per km²).

The massive connectivity may be configured with a large connection density, a small packet size, and burst of traffic with a large inter-arrival time. To address the characteristics of the massive connectivity, grant-free NOMA configuration may be provided.

In one aspect, to support the large connection density, the NOMA configuration may increase the multiplexing gain and UP cell capacity. NOMA transmission may differ from traditional orthogonal multiple access (OMA) transmission. In OMA transmissions, transmissions from different UEs are orthogonal to each other in time and/or frequency resources. Thus, the base station is able to identify the UE sending the transmission based on the time and/or frequency resources on which the transmission is received. In NOMA transmissions, different UEs may share the time and frequency resources, e.g., data transmissions from different UEs may not be orthogonal. NOMA transmissions may include a first data transmission and/or retransmissions. Such NOMA transmissions from UEs may be referred to as non-orthogonal uplink transmissions.

In another aspect, to support the small packet size, the grant-free operation may reduce the control signal overhead. NOMA transmission may comprise a small payload. NOMA transmissions may enable possible savings of systems overhead, power reduction, and latency reduction. NOMA may be used in connection with massive machine-type communications (mMTC), ultra-reliable low-latency communications (URLLC), and enhanced mobile broadband (eMBB), e.g., for communication with small payloads. The aspects presented herein can be applicable to grant-based and/or grant-free transmissions.

In another aspect, to support the burst of traffic with a large inter-arrival time, the grant-free NOMA configuration may provide adoptable and versatile resource allocation to achieve an efficient resource utilization. NOMA deployments may help to reduce signaling overhead. Signaling overhead reduction may be associated with power savings and latency reduction. Signaling in NOMA transmissions may include control channel signaling, e.g., PDCCH, which can carry the downlink and uplink scheduling information.

Compared to grant-based NOMA transmissions, grant-free or configured grant NOMA transmissions can save the signaling overhead for a scheduling request (SR) and dynamic DCI. Grant-based transmissions can use an uplink grant or SR, while grant-free transmissions may be sent without a specific uplink grant from the base station and/or SR from the UE. For grant-based NOMA, the NOMA data transmissions on the uplink may be scheduled by an uplink grant. In some aspects, the uplink grant can be transmitted on the PDCCH with DCI. Compared to grant-based OMA transmission, grant-based and grant-free NOMA can help to save the signaling overhead associated with resource allocation indication. In NOMA transmissions, even in grant-based NOMA transmissions, the NOMA UE can share the time and frequency resources with other NOMA UEs. In some aspects, a resource allocation indication can be common to multiple NOMA UEs. As will be discussed further herein, signaling overhead reduction schemes can be used with for grant-based and grant-free NOMA transmissions.

There are several ways that NOMA transmissions according to the present disclosure can reduce signaling overhead. For example, some NOMA transmissions can allow for a more efficient way to allocate resources for a first NOMA transmission, as well as any subsequent re-transmission. Shared time and/or frequency resources, e.g., for a group of NOMA UEs, can be partitioned into NOMA-specific resource units (NA-RUs). The NA-RUs may be indexed, and the indexes may be used to indicate NOMA resources to NOMA UEs.

In some aspects, the NOMA may be provided based on a UE-specific bit-level scrambling for multiple access (MA) signature. That is, as a form of resource spreading multiple access (RSMA), the data communication associated with the NOMA may be scrambled at a bit level that is specific to the UE, and the UE and the network node (or other UEs in sidelink) may separate the data communication from the UE from other signals.

One example of grant-free operation is the 2 step RACH procedure. In the 2-step RACH procedure in an idle/inactive state, a Msg-A including PRACH preamble and the PUSCH and the PUSCH DMRS are transmitted to the network. Since the UE is not transmitting the PRACH preamble and waiting for the grant to transmit the PUSCH and PUSCH DMRS, the Msg-A is transmitted using asynchronous condition among multiple UEs. The timing advance (TA) may not be available and the PRACH may provide timing information for each UEs. Also, the DMRS port and/or the PUSCH scrambling is associated with the PRACH resource. In comparison, a configured grant in the connected state or inactive state may use the synchronous condition among the multiple UEs, TA may be available for each user, and the DMRS port and/or the PUSCH scrambling sequences may be assigned UE-specifically. Here, the collision may happen if more than one UEs choose non-differentiable (e.g., the same) resources under grant-free setup. Here the per-user collision rate may be determined as P(colᵤₛₑᵣ)=1−(1−1/S)^{M-1}, where S refers to the number of differentiable resources, which can be represented as min(number of associated PRACH sequence, number of DMRS ports, number of MA signatures), and M refers to the number of simultaneously transmitting users. To maintain the collision rate smaller than the configured BLER, S may be increased or M may be reduced. For example, the number of simultaneous users may be maintained to be less than or equal to 6 to maintain the collision rate less than 10%.

In some aspects, the above explained characteristics of the grant-free NOMA configuration may be applied to sidelink communication with increased number of UEs (e.g., IoT devices). The sidelink communication may also have a large connection density, a small packet size, and burst of traffic with a large inter-arrival time, and the grant-free NOMA configuration may support the increased number of UEs and low-latency application. To enable NOMA operation on grant-free allocations, the network node may configure new resource pools (RPs) for NOMA, or configured grants dedicated for NOMA where many UEs may use them at the same time. Here, the RP may refer to continuous PRBs allocated in a continuous or discontinuous slots configured for SL transmissions. In addition, to enable the NOMA, multiple UEs may be separated under the grant-free allocation by selecting SCI configuration, PSSCH DMRS configuration, SCI frequency domain orthogonal cover codes (FD-OCC) configuration, power control for PSCCH, power control for PSSCH, and/or symbols or sub-channels with a certain level of randomness.

Sidelink communication may be based on different types or modes of resource allocation mechanisms. In a first resource allocation mode (which may be referred to herein as “mode 1” SL resource allocation), centralized resource allocation may be provided by a network entity. For example, a base station may determine resources for sidelink communication and may allocate resources to different UEs to use for sidelink transmissions. In this first mode, a UE receives the allocation of sidelink resources from the base station. In a second resource allocation mode (which may be referred to herein as “mode 2” SL resource allocation), distributed resource allocation may be provided. In the mode 2 SL resource allocation, each UE may autonomously determine resources to use for sidelink transmission. In order to coordinate the selection of sidelink resources by individual UEs, each UE may use a sensing technique to monitor for resource reservations by other sidelink UEs and may select resources for sidelink transmissions from unreserved resources. Devices communicating based on sidelink, may determine one or more radio resources in the time and frequency domain that are used by other devices in order to select transmission resources that avoid collisions with other devices.

Based on the resource allocation mode, a UE may transmit or broadcast a PSCCH including sidelink control information (SCI) format 1 (SCI-1) indicating the resource reservation of PSSCH carrying the sidelink data payload and/or SCI format 2 (SCI-2). In one aspect, the PSCCH may be scrambled by a sequence initialized at a fixed value (e.g., Cᵢₙᵢₜ=1010). In another aspect, the PSCCH may be transmitted from a single port. In another aspect, DMRS FD-OCC may be provided for the PSCCH, and the transmitting UE may select one of the sequences from the following table to provide the DMRS FD-OCC. Accordingly, the UE may use one of the three different sequences to distinguish the PSCCH from other sidelink communication.

| | W_{f,i}(k′) | | |
|---|---|---|---|
| k′ | i = 0 | i = 1 | i = 2 |
| 0 | 1 | 1 | 1 |
| 1 | 1 | e^{j2/3π} | e^{-j2/3π} |
| 2 | 1 | e^{-j2/3π} | e^{j2/3π} |

A SL Tx SL UE may determine to reserve the sidelink resources and indicate the DMRS pattern in the SCI. That is, the SL Tx SL UE may include DMRS configuration including the DMRS pattern in the SCI and transmit the SCI in the PSCCH to reserve the sidelink resources. The DMRS pattern may include a number of DMRS symbols, DMRS type, location of DMRS symbols, etc. The UE may also indicate an index of code domain multiplexing group, an index of ports used for the transmission, or the index of code-division multiplexing (CDM) groups and/or the ports and/or their indices that can be used by other SL transmitters if they decide to reuse the same resource.

The SL Rx SL UE may use the information about the CDM group index and/or the port index that are free and usable (e.g., not reserved) to decide whether there will be any “potential” interferer on the same resources and whether it is utilized to perform an interference cancelation. To enhance the interference estimation, data collision may be reduced or avoided for the DMRS. Accordingly, the Tx SL UE may select the DMRS pattern from the set of available patterns. The set of available patterns may be configured for the RP of the sidelink communication. In one aspect, the PSSCH DMRS sequence may be a function of PSCCH cyclic redundancy check (CRC). That is, the PSSCH DMRS may be determine based on the PSSCH CRC. The PSCCH CRC may be a function of SCI1 payload and setting of different fields. That is, the UE may determine the PSCCH CRC based on the SCI1 payload and other configurations. The UE may configure the sidelink power control for transmitting the sidelink communication. The UE may determine a power P_{PSSCH,b,c}(i) for a PSSCH transmission on a resource pool in symbols where a corresponding PSCCH is not transmitted in PSCCH-PSSCH transmission occasion i as P_{PSSCH}(i)=min (P_{CMAX}, P_{MAX,CBR}, Min(P_{PSSCH,D}(i), P_{PSSCH,SL}(i))) [dBm], where P_{CMAX} may be a defined maximum value, and P_{MAX,CBR} may be determined by a value of sl-MaxTransPOwer based on a priority level of the PSSCH transmission and a CBR range that includes a CBR measured in a previous slot (e.g., slot i−N). If sl-MaxTransPOwer-r16 is not provided, then P_{MAX,CBR}=P_{CMAX}·P_{PSSCH,D}(i) may be determines as 1) P_{PSSCH,D}(i)=P_{O,D}+10 log₁₀ (2^{μ}·M_{RB}^{PUSSCH}(i))+α_{D}·PL_{D} [dBm] if dl-P0-PSSCH-PSCCH is provided, 2) P_{PSSCH,D}(i)=min(P_{CMAX}, P_{MAX,CBR}, P_{PSSCH,SL}(i)) [dBm] if sl-P0-PSSCH-PSCCH is provided, or 3) P_{PSSCH,D}(i)=M in (P_{CMAX}, P_{MAX,CBR}) [dBm], where P_{O,D} may be a value of dl-P0-PSSCH-PSCCH, a D may be a value of dl-Alpha-PSSCH-PSCCH or 1, the PL_{D}=PL_{b,f,c}(q_{d}) except that the RS resource is the one the UE uses for determining a power of a PUSCH transmission scheduled by a DCI format 0_0 when the UE is configured to monitor PDCCH for detection of DCI format 0_0 or the RS resource is the one corresponding to the SS/PBCH block the UE uses to obtain MIB when the UE is not configured to monitor PDCCH for detection of DCI format 0_0, and the M_{RB}^{PUSSCH}(i) may be a number of resource blocks for the PSSCH transmission occasion i and μ is a SCS configuration.

In case sl-P0-PSSCH-PSCCH is provided and a SCI format scheduling the PSSCH transmission includes a cast type indicator field indicating unicast, P_{PSSCH,SL}(i) may be P_{PSSCH,SL}(i)=P_{O,SL}+10 log₁₀ (2^{μ}·M_{RB}^{PUSSCH}(i))=α_{SL}·PL_{SL} [dBm] or P_{PSSCH,SL}(i)=min(P_{CMAX}, P_{PSSCH,D}(i)) [dBm], where P_{O,SL}, may be a value of sl-P0-PSSCH-PSCCH, α_{SL} may be a value of sl-Alpha-PSSCH-PSCCH or 1, PL_{SL} may be PL_{SL}=referenceSignalPOwer−higher layer filtered RSRP, where referenceSignalPOwer may be obtained from a PSSCH transmit power per RE summed over the antenna ports of the UE, higher layer filtered across PSSCH transmission occasions using a filter configuration provided by sl-filterCoefficient, and higher layer filtered RSRP may be an RSRP that is reported to the UE from a UE receiving the PSCCH-PSSCH transmission and is obtained from a PSSCH DMRS using a filter configuration provided by sl-filterCoefficient. M_{RB}^{PSSCH}(i) may be a number of resource blocks for PSCCH-PSSCH transmission occasion i and μ is a SCS configuration.

The UE may split the power P_{PSSCH}(i) equally across the antenna ports on which the

UE transmits the PSSCH with non-zero power and the UE may determine a power P_{PSSCH2,b,c}(i) for a PSSCH transmission on a resource pool in the symbols where a corresponding PSCCH is transmitted in PSCCH-PSSCH transmission occasion i as

$${P}_{PSSCH 2} ( i ) = 10 {log}_{10} ( \frac{{M}_{R B}^{P S S C H} ( i ) - {M}_{R B}^{P S C C H} ( i )}{{M}_{R B}^{P S S C H} ( i )} ) + {P}_{P S S C H} [ dB m ]$$

where M_{RB}^{PSSCH}(i) is a number of resource blocks for the corresponding PSCCH transmission in PSCCH-PSSCH transmission occasion i.

To enable the NOMA operation on grant-free allocations for the sidelink communication, the network node may configure a dedicated RPs for the NOMA operation, or configured grants dedicated for the NOMA operation where multiple UEs may use them at the same time. In addition, to enable NOMA, random selection of SCI (e.g., the PSCCH) and/or PSSCH DMRS configurations, SCI FD-OCC configuration, power control configuration for the PSCCH, power control configuration for the PSSCH, and separate configurations for symbols or sub-channels may be configured to separate each UEs of the multiple UEs in the grant-free NOMA operation.

In some aspects, the SL UEs may be configured with new RPs enabled for the NOMA operation for the grant-free operation. That is, the network node may transmit at least one configuration of a set of RPs associated with the grant-free NOMA operation for the SL communication. In one aspect, on the RP level, the network node may configure a set of FD-OCC (e.g., orthogonal or non-orthogonal) and a set of DMRS configuration IDs to be used for the PSCCH transmission (e.g., the SCI) and the PSSCH transmission. The at least one configuration of the set of RPs may include a set of FD-OCCs and DMRS configuration IDs associated with at least one of the PSCCH or the PSSCH.

In another aspect, instead of assigning a whole RP, at least one sub-RP may be assigned for the grant-free operation. Here, sub-RP may refer to at least a part of the RP. That is, the at least one configuration of the set of RPs may indicate the at least one sub-RP assigned for the grant-free NOMA for the sidelink communication.

In another aspect, instead of assigning certain RPs, network node can assign certain configured grants for grant-free operation, which may be shared among a set of UEs, to use the grant-free NOMA operation. In the mode 1 SL resource allocation, the network node may assign the resources to the UEs, and the resource allocation may be configured dynamically (e.g., dynamic grants) or periodically or semi-persistently (e.g., configured grants). In cased of the mode 1 SL resource allocation, the network node may transmit a dedicated configured grants and instruct a set of UEs to share the set of RPs for the grant-free NOMA operation. In one example, the configured grants of the set of RPs for the grant-free NOMA operation may be valid until receiving new configured grants. In another example, the configured grants of the set of RPs for the grant-free NOMA operation may be valid for a time period.

In another aspect, the grant-free NOMA operation may be enabled or disabled for some type of cast or priority and/or QoS of the data. In one aspect, the network node may transmit an instruction to activate or deactivate the at least one configuration of a set of RPs associated with the grant-free NOMA operation for the SL communication. The instruction may instruct the UE to activate or deactivate the at least one configuration of a set of RPs associated with the grant-free NOMA operation based on at least one of a cast type, a data priority, or a quality of service (QoS). Here, the cast type may indicate whether the SL communication is a multicast (e.g., broadcasting) transmission or a unicast (e.g., point-to-point communication) transmission. In one aspect, the instruction to activate or deactivate the at least one configuration of a set of RPs associated with the grant-free NOMA operation may be received via at least one of a physical layer (L1) signal, a media access control (MAC) layer (L2) signal, or a radio resource control (RRC) layer (L3) signal. In another aspect, the activation of the at least one configuration of a set of RPs associated with the grant-free NOMA operation may be based on a timer. That is, the instruction to activate or deactivate the grant-free NOMA operation may include an indication of a timer, and the NOMA may be activated or deactivated until an expiration of the timer.

In some aspects, the UEs may be separated in the power domain, and each UE may select power configurations for transmitting the PSCCH or the PSSCH for the set of RPs from a set of available power configurations. That is, each UE may be configured to select a power configuration for transmitting the SL channels in the set of RPs associated with the grant-free NOMA operation. The power configurations may include at least one power delta (e.g., Δ) or a P_{O}. In one aspect, a set of available power configurations may be configured for the set of RPs, and each UE may select the power configuration from the set of available power configurations per cast. For example, a UE may select the P_{O} parameter from a set of available power configurations and determine the transmission power to transmit its data.

In one aspect, each UE may randomly selected the power configuration from the set of available power configurations. In another aspect, each UEs may select the power configuration based on at least one of a source ID of the Tx SL UE, a destination ID of the Tx SL UE, a zone ID associated with the Tx SL UE, a data priority, a quality of service (QoS), one or more configured IDs for randomization, or a cast type. If the SL channel is a PSSCH, the UE may select the power configuration based on the PSCCH CRC, similar to selecting the PSSCH DMRS sequence based on a function of the PSCCH CRC.

For example, each UE may select a random P_{O} from a plurality of P_{O}s or select the Δ_{NOMA} based on the source ID. Accordingly, the SL transmissions on the grant-free NOMA operation may be separated in the power domain based on the power control configurations for decoding (e.g., for interference cancellation). The UE separation may be based on a function of distance and pathloss where each distance and/or pathloss may have its own P_{O} or power delta (e.g., Δ) configurations.

In some aspects, to estimate the UE's channels at the common receiver, different DMRS configurations may be used for transmitting the SL transmissions on the set of RPs associated with the grant-free NOMA operation. That is, different DMRS may be used to estimate each UE's channels at the common receiver. Accordingly, the UE configured with the at least one configuration of a set of RPs associated with the grant-free NOMA operation for the SL communication may be configured to select the PSCCH DMRS configuration (e.g., the DMRS pattern or the DMRS configuration) and the PSSCH DMRS configuration from a plurality of configurations per the set of RPs. Here, the selection of the PSCCH DMRS configuration and the PSSCH DMRS configuration may be based at least one of a source ID of the Tx SL UE, a destination ID of the Tx SL UE, a zone ID associated with the Tx SL UE, a data priority, a QoS (adding another dimension to separate the UEs), the CRC of the SCI-1, a configured ID to be used for randomization, or the cast type. Here, the one or more configured IDs for randomization may be configured using the RRC message, the MAC-CE, an SL wakeup signal (WUS), or a dedicated PSSCH.

In one aspect, a basic DMRS pattern and configuration may be configured, while the DMRS scrambling ID may be determined as a function of the above-mentioned parameters to select different DMRS configurations for each of the UE. For example, the DMRS scrambling ID may be selected based on the source ID of the Tx SL UE or the destination ID of the Rx SL UE.

In case of the mode 1 SL resource allocation that the network node, a programmable logic channel (PLC), or a primary UE may control the configurations, and the network node, the PLC, or the primary UE may assign separate configurations associated with the grant-free NOMA (e.g., power configuration, FD-OCC, DMRS IDs, etc.) to control the configurations.

In some aspects, a dedicated design for PSCCH DMRS FD-OCC may be provided for the grant-free NOMA operation. As proffered, the Tx SL UE may randomly pick one of the DMRS FD-OCC. For example, based on the following table of the DMRS FD-OCC using the exponential terms e^{j2/3π}, the UE may select one sequence from the three different sequences.

| | W_{f,i}(k′) | | |
|---|---|---|---|
| k′ | i = 0 | i = 1 | i = 2 |
| 0 | 1 | 1 | 1 |
| 1 | 1 | e^{j2/3π} | e^{-j2/3π} |
| 2 | 1 | e^{-j2/3π} | e^{j2/3π} |

Because there are three different sequences, two Tx SL UEs may select the same FD-OCC, and in the grant-free NOMA operation, the two Tx SL UEs with the same FD-OCC may experience high interference, and the Rx SL UEs may not probably decode the SCI-1 in the PSCCH. If the Rx SL UEs cannot decode the SCI-1, the entire resource may be wasted for all of the SL UEs trying to communicate with the Rx SL UEs. Furthermore, because of the retransmissions caused by the failed transmission may reduce the available resources and affect the future reservations for the sidelink transmissions.

In one aspect, an adding oversampling factor may be added to the exponential terms e^{j2/3π}. This may be analogous to oversampling a DFT matrix of size N=3 into size N=3*O with the oversampling factor of O. That is, based on a matrix size N=3 and the oversampling factor of O, The FD-OCC may separate more Tx SL UEs, at the cost of more channel estimations. To support the dedicated FD-OCC with the oversampling factor of O, the Rx SL UEs may need to perform increased number of channel estimation, but may separate one UE from another. For example, the oversampling factor may be “O” the matrix size of N=3. The number of FD-OCC may extend to 3*O=12. If the oversampling factor O is 4, the following set of DFT vectors may be repetition of a first set of the FD-OCC identified with index of 0, 4, 8, a second set with 1, 5, 9, a third set with 2, 6, 10, and a fourth set with 3, 7, 11.

$$F = {DFT}_{ON \vert N columns} = {[ \begin{matrix}1 & 1 & 1 & … & 1 \\ 1 & {e}^{\frac{j 2 π}{ON}} & {e}^{\frac{j 2 π ( 2 )}{ON}} & … & {e}^{\frac{j 2 π ( N - 1 )}{ON}} \\ 1 & {e}^{\frac{j 2 π ( 2 )}{ON}} & {e}^{\frac{j 2 π ( 4 )}{ON}} & … & {e}^{\frac{j 2 π ( 2 ) ( N - 1 )}{ON}} \\ ⋮ & ⋮ & ⋮ & ⋮ & ⋮ \\ 1 & {e}^{\frac{j 2 π ( ON - 1 )}{ON}} & {e}^{\frac{j 2 π ( ON - 1 ) ( 2 )}{ON}} & … & {e}^{\frac{j 2 π ( ON - 1 ) ( N - 1 )}{ON}}\end{matrix} ]}_{ON \times N}$$

To enable the NOMA operation on grant-free allocations, the network node may configure some transmissions or occasions to perform the NOMA operation. That is, the network node may configure different configurations for transmissions/retransmissions of transport blocks (TBs). In addition, the PSFCH may be designed to occupy multiple UEs using the NOMA, and a dedicated design for the PSFCH under the NOMA based on the transmissions on the PSSCH may be provided. In one aspect, the network node may allow a set of UEs to transmit the TBs in a first

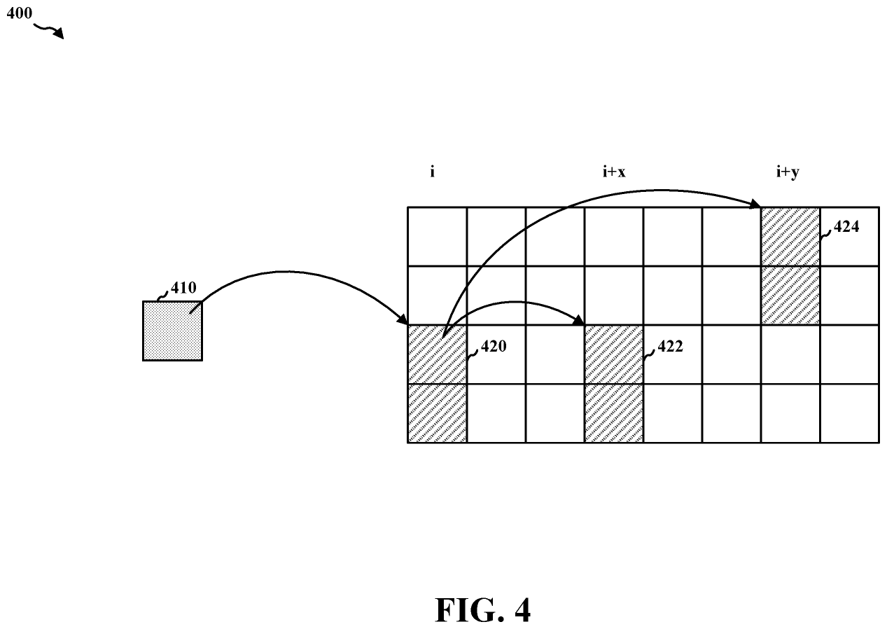

transmission occasion configured with the grant-free NOMA operation for sidelink communication. In one example, The SCI scheduling the first transmission occasion may reserve up to three transmission occasions, and the TB may be retransmitted up to two (2) times in the two transmission occasions reserved by the SCI after the first transmission occasion. The network node may restrict the retransmissions to a subset of UEs among the set of UEs to reduce the number of transmissions in the subsequent transmission occasions. In another aspect, the PSFCH may be designed to support 1) enabling the grant-free NOMA operation on the PSFCH (e.g., multiple UEs allowed to use the PSSCH PRB under the NOMA operation, and 2) dedicated design of the PSFCH for the NOMA operation (e.g., new timeline for PSFCH under the NOMA operation) FIG. 4 is a diagram 400 illustrating SL resource reservation in sidelink communication. The diagram 400 may include a SCI 410, a first set of resources 420, a second set of resources 422, and a third set of resources 424. The Tx SL UE may transmit the SCI 410 to reserve at least one set of resources to transmit one or more PSSCHs. In one example, the SCI 410 may reserve set of resources for one (1), two (2), or three (3) transmissions. The maximum number of reservations may be configured for the Tx SL UE, or the network node may configure the maximum number of reservations for the Tx SL UE. Here, SCI 410 may reserve the first set of resources 420, the second set of resources 422, and the third set of resources 424. In one aspect, the multiple reservations may have the same number of sub-channels, and may have different starting sub-channel between each reservation. In another aspect, the reservation in the SCI may be enabled to be repeated with the signaled period. Here, the SCI 410 may be configured based on the following configuration to reserve

the first set of resources 420, the second set of resources 422, and the third set of resources 424. Accordingly, the SCI 410 may reserve the first set of resources 420 at the it h slot, the second set of resources 422 at the (i+x)^{th} slot, and the third set of resources 424 at the (i+y)^{th} slot.

Reservations signaled by an SCI in slot i

| Reservation | # Sub-channels | Slot |
|---|---|---|
| 1 | z | i |
| 2 | z | i + x 0 < x ≤ 31 |
| 3 | z | i + y x < y ≤ 31 |

Here, x may be 3 and y may be 6. Accordingly, the SCI 410 may reserve the first set of resources 420 at the i^{th} slot, the second set of resources 422 at the (i+3)^{th} slot, and the third set of resources 424 at the (i+6)^{th} slot.

In one aspect, the second set of resources 422 and the third set of resources 424 may be used for retransmission of the TB transmitted in the first set of resources 420. That is, the Tx SL UE may reserve the first set of resources 420 as the transmission occasion of a TB, and reserve the second set of resources 422 and the third set of resources 424 as the first and second retransmission occasions of the TB in case the TB transmission in the first set of resources 420 (e.g., the transmission occasion) is not successfully delivered (e.g., receiving a NACK).

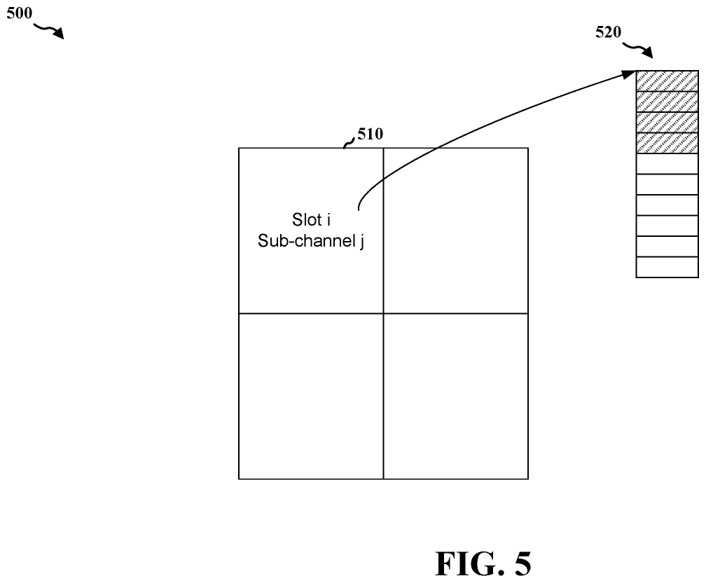

FIG. 5 is an example 500 of assigning PSFCH resources in sidelink communication. The example 500 may include a first set of PRBs 510 for the PSSCH and a second set of PRBs 520 assigned for the PSFCH and illustrate how the UE may select the PRB among the second set of PRBs 520 for transmitting the PSFCH carrying the verification bits. The mapping between the PSSCH and the PSFCH may be based on at least one of 1) the starting sub-channel of the PSSCH, 2) the slot containing the PSSCH, 3) the source ID, or 4) the destination ID. In a case of a groupcast with a group of UEs including one UE acting as a transmission (Tx) UE and the rest of UEs acting as reception (Rx) UEs, option 2 may support the ACK/NACK feedback from all Rx SL UEs, and therefore, the number of available PSFCH resource may be configured greater than or equal to the number of UEs in the groupcast.

A time period parameter, e.g., periodPSFCHresource, may be provided to a UE and may represent a period in slots for PSFCH transmission in the resource pool. In some examples, the parameter periodPSFCHresource may be 0, 1, 2, or 4 (0 representing no PSFCH, 1 representing 1 slot, 2 representing 2 slots, and 4 representing 4 slots). In some aspects, a PSFCH transmission timing may be the first slot with a PSFCH resource after a PSSCH or after a gap (which may be represented by a MinTimeGapPSFCH parameter) after the PSSCH. In some aspects, a set of PRBs in a resource pool for a PSFCH in a slot may be configured for the UE and may be represented by a parameter sl-PSFCH-RB-Set, a parameter M_{PRB,set}^{PSFCH} may represent the number of resources in the sl-PSFCH-RB-Set. In some aspects, a number of PSSCH slots corresponding to the PSFCH slot may be represented by a parameter N_{PSSCH}^{PSFCH}. In some aspects, each subchannel/slot may have a number of PRBs represented by

$${M}_{s u b c h , s l o t}^{P S F C H} = \frac{{M}_{P RB , set}^{P S F C H}}{{N}_{P S S C H}^{P S F C H} \times {N}_{s u b c h}} .$$

The parameter N_{subch} may represent a number of subchannels. In some aspects, time first mapping may be used from a PSSCH resource to PSFCH PRBs.

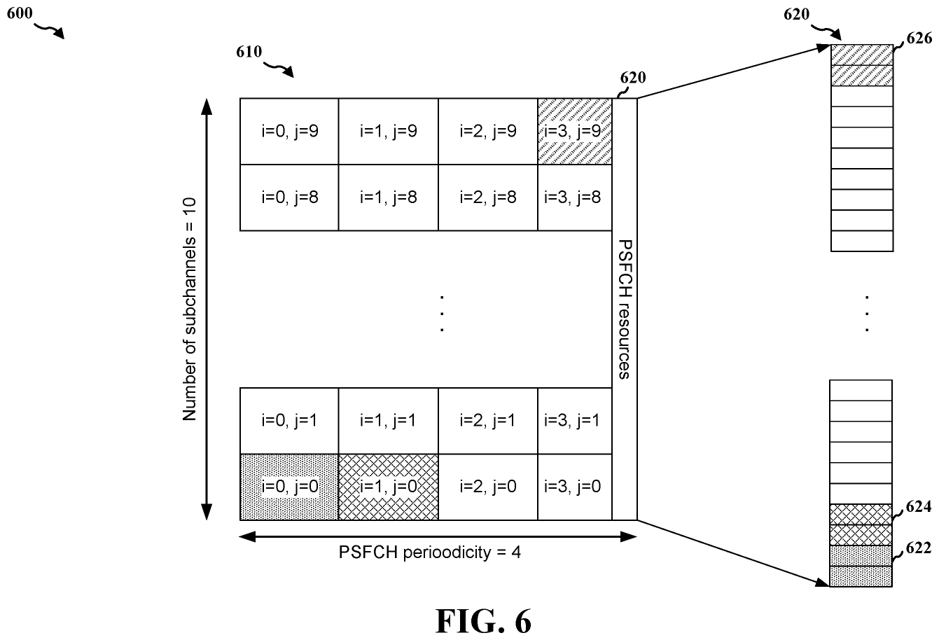

FIG. 6 is an example 600 of assigning PSFCH resources in sidelink communication. The example 600 may include a first set of PRBs 610 for the PSSCH and a second set of PRBs 620 assigned for the PSFCH.

The PSFCH resource may be mapped based on the corresponding PSSCH resource. The mapping between the PSSCH resource and the corresponding PSFCH resource may be based on at least one of the following the starting sub-channel of the PSSCH (e.g., sl-PSFCH-CandidateResourceType may be configured as startSubCH) or the number of sub-channels in the PSSCH (e.g., sl-PSFCH-CandidateResourceType configured as allocSubCH), the slot containing the PSSCH, the source ID, or the destination ID. The number of available PSFCH resources may be greater than or equal to the number of UEs in group cast option 2.

The UE may allocate [(i+j·N_{PSSCH}^{PSFCH})·M_{subch,slot}^{PSFCH}, (i+1+j·N_{PSSCH}^{PSFCH})·M_{subch,slot}^{PSFCH}−1] PRBs from M_{PRB,set}^{PSFCH} PRBs for the PSSCH on the slot i and the sub-channel j. Here, 0≤i≤N_{PSSCH}^{PSFCH} and 0≤j≤N_{subch}. In some aspects, M_{PRB,set}^{PSFCH}=α·N_{subch}·N_{PSSCH}^{PSFCH} and

$${M}_{s u bch , slot}^{P S F C H} = \frac{{M}_{PRB , set}^{P S F C H}}{{N}_{s u b c h} \cdot {N}_{P S S C H}^{P S F C H}} ,$$

where N_{PSSCH}^{PSFCH} may refer to a number of the PSSCH slots associated with the PSFCH slot. For example, N_{PSSCH}^{PSFCH} may be determined by periodPSFCHresource. The parameter periodPSFCHresource may indicate the PFSCH periodicity, in a number of slots, in a resource pool. It can be set to {0,1,2,4}. If it is set to 0, the PSFCH transmissions from the UE in the resource pool may be disabled.

The UE may transmit the PSFCH in a first slot that includes PSFCH resources and in at least a number of slots of the resource pool after a last slot of the PSSCH reception. A parameter MinTimeGapPSFCH may provide the number of slots. A parameter rbSetPSFCH may refer to a set of N_{PRB,set}^{PSFCH} PRBs in a resource pool for PSFCH transmission. A parameter numSubchannel may refer to a number of sub-channels N_{subch} for the resource pool.

For example, N_{PSSCH}^{PSFCH} may be 4, which represents the PSFCH periodicity, N_{subch} may be 10, which represents the number of subchannels for the resource pool. Accordingly, M_{subch,slot}^{PSFCH}=80/(4*10)=2, and therefore, 80 PRBs may be assigned for the corresponding PSFCH. For each slot and subchannel, two PRBs may be sequentially assigned for the corresponding PSFCH. In one example, the first two PRBs 622 may be assigned for the PSFCH corresponding to the PSSCH on slot 0, subchannel 0. In another example, the second two PRBs 624 may be assigned for the PSFCH corresponding to the PSSCH on slot 1, subchannel 0. In another example, the last two PRBs 626 may be assigned for the PSFCH corresponding to the PSSCH on slot 3, subchannel 9. According to the example 600, two PRBs may be assigned for communicating the PSFCH including the verification bits, however, the PSFCH may be sent on one of the two PRBs assigned for communicating the PSFCH. The UE may select the one PRB based on the secret key or the hashed value of the secret key.

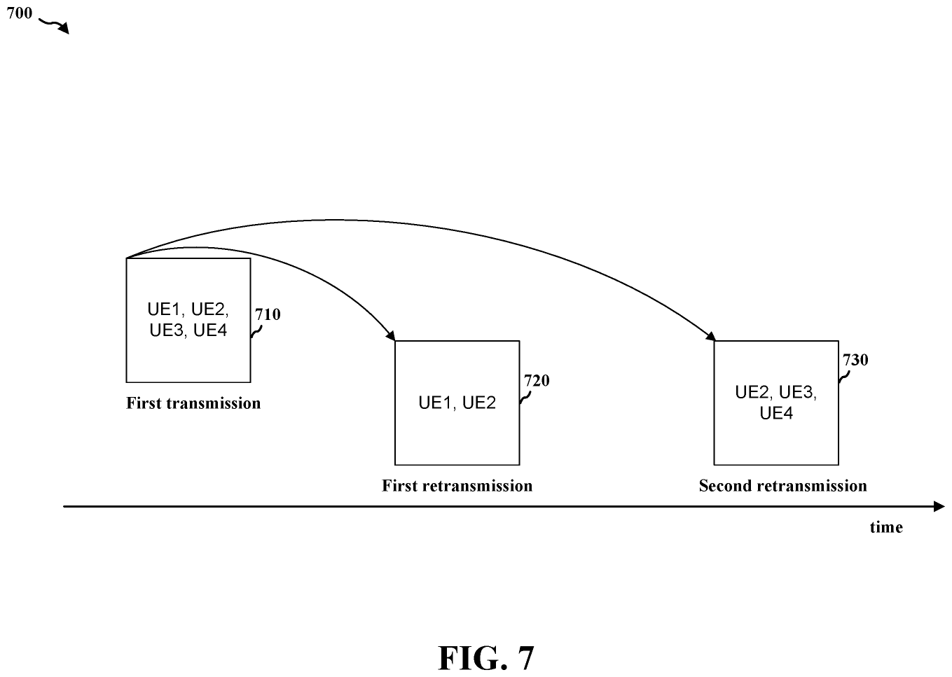

FIG. 7 is a diagram 700 illustrating SL resource reservation in sidelink communication. The diagram 700 shows three sets of resources, a first set of resources 710, a second set of resources 720, and a third set of resources 730. Here, the first set of resources 710, the second set of resources 720, and the third set of resources 730 may be configured for the NOMA operation for a set of UEs. That is, a network node may configure the first set of resources 710, the second set of resources 720, and the third set of resources 730 for the set of UEs to perform NOMA sidelink communication. In one example, one UE from the set of UEs may reserve the first set of resources 710 for the initial transmission of a TB, and reserve the second set of resources 720 and/or the third set of resources 730 for the retransmission of the TB. Because the set of UEs including multiple UEs may transmit sidelink TBs simultaneously, the risk of collision may be reduced by reducing the number of UEs simultaneously transmitting signals.

In some aspects, a first transmission of a grant (configured or dynamic) can be used by a first set of UEs to perform NOMA operation, and a subset of UEs may be configured to use the retransmission occasion (e.g., the second set of resources 720 and the third set of resources 730). The subset of UEs configured to perform the retransmission may be limited to UEs that received NACK in response to transmitting the SL TB in the first transmission occasion. This subset may be limited to one UE. Then, another subset from the UEs with NACKed TB during the first retransmission occasion can use the second retransmission occasion.

That is, a UE from the set of UEs configured to perform NOMA sidelink communication within the first set of resources 710, the second set of resources 720, and the third set of resources 730 may be configured to transmit a TB via the first transmission occasion (e.g., the first set of resources 710) associated with grant-free non-orthogonal multiple access (NOMA) for the sidelink communication, and a subset of UEs that had received a NACK in response to transmitting the TB may be configured to perform a retransmission of the TB via a first retransmission occasion (e.g., the second set of resources 720). Furthermore, another subset of UEs that had received the NACK in response to transmitting the TB may be configured to perform a retransmission of the TB via a second retransmission occasion (e.g., the third set of resources 730).

By limiting or reducing the number of UEs performing retransmission during the second set of resources 720 or the third set of resources 730 to a subset of UEs rather than the total set of UEs, the risk of collision for the retransmission may be reduced. For example, the first set of resources 710 may be assigned for four UEs, UE1, UE2, UE3, and UE4 to perform NOMA operation. Accordingly, each of UE1, UE2, UE3, and UE4 may be configured to transmit respective SL TBs in the first set of resources 710 reserved as the first transmission occasion. In response to the first transmissions of the respective SL TBs, all of UE1, UE2, UE3, and UE4 may receive the NACK indicating that the first transmission in the first set of resources 710 were not successful. Based on the configuration, a subset of UEs including UE1 and UE2 from the UEs that received NACK based on the first transmission of the SL TB in the first transmission occasion may be configured to perform a retransmission of the SL TB in the second set of resources 720 (e.g., the first retransmission occasion). The configuration may also provide that a second subset of UEs including UE2, UE3, and UE4 may be configured to perform a retransmission of the SL TB in the third set of resources 720 (e.g., the second retransmission occasion).

In some aspects, the decision could be based on priority and QoS of transmissions. The Rx SL UE may decide this and send it on PSFCH resources feedback. In one aspect, the decision may be a bitmap indicating a next transmission or for first or second retransmission, a dedicated feedback for downselecting the UEs or retransmissions. In another aspect, the retransmission pattern regarding which UEs to be selected for each transmission or retransmission occasions may be indicated by the RRC message or the MAC-CE, or transmitted in the L1 indication before the first transmission occasion and be agreed between the set of UEs performing the NOMA and the Rx SL UE.

In some aspects, the retransmission of the TB may have different configurations from the first transmission of the TB. That is, the retransmission of the TB and the first transmission of the TB may have different power control configurations or different DMRS configurations. The configurations may be different between different retransmissions (e.g., between the first retransmission and the second retransmission).

In one aspect, the power control parameters/configurations during each retransmission may be same or different, in part based on a change of the subset of UEs participating the NOMA operation. That is, a power configuration associated with the retransmission of the TB may be based on the subset of UEs configured to perform the retransmission. For example, the first subset of UEs including UE1 and UE2 may be configured to perform the first retransmission of the TB in the second set of resources 720 using a first power control parameter/configurations based on the first subset of UEs including UE1 and UE2, and the second subset of UEs including UE2, UE3, and UE4 may be configured to perform the second retransmission of the TB in the third set of resources 730 using a second power control parameter/configurations based on the second subset of UEs including UE2, UE3, and UE4. Accordingly, the first power control parameter/configurations and the second power control parameter/configurations may be different for the first retransmission and the second retransmission.

In another aspect, the UEs can use the same or different DMRS configurations for transmitting the PSCCH and/or the PSSCH across the retransmissions based on a change of the subset of UEs participating the NOMA operation. That is, the DMRS configuration associated with the retransmission of the TB may be based on the subset of UEs configured to perform the retransmission. Here, the DMRS configuration may include the DMRS pattern. For example, the first subset of UEs including UE1 and UE2 may be configured to perform the first retransmission of the TB in the second set of resources 720 using a first DMRS configuration based on the first subset of UEs including UE1 and UE2, and the second subset of UEs including UE2, UE3, and UE4 may be configured to perform the second retransmission of the TB in the third set of resources 730 using a second power control parameter/configurations based on the second subset of UEs including UE2, UE3, and UE4. Accordingly, the first DMRS configuration and the second DMRS configuration may be different for the first retransmission and the second retransmission.

In another aspect, some randomness may be introduced in determining or downselecting the subset of UEs to utilize the first transmission occasion and/or the retransmission occasions. That is, the network node, the PLC, the primary UE, or the Rx SL UE may configure certain access probability for each UE of the set of UEs, and the set of UEs to perform the transmission in the first transmission occasion and/or the subset of UEs to perform the retransmissions in the first or second retransmission occasions may be determined based on the access probability of the each UE of the set of UEs. By introducing the randomness to selecting the set of UEs for the set of UEs and/or the subset of UEs for retransmission, the risk of the collision may be further reduced.

In another aspect, the network node, the PLC, or the primary UE may send an indication to convert a grant-free occasion to a grant-based occasion and assign the grant-based occasion to a single UE or set of UEs in a MU-MIMO manner. In another example, the network node, the PLC, or the primary UE may instruct to convert a grant-based occasion to a grant-free occasion.

In another aspect, the design of the PSFCH for UEs applying the NOMA transmissions may be configured based on the grant free NOMA operation. That is, based on at least one of the transmission or the retransmission of the TB, the Tx SL UE may receive the PSFCH based on the grant-free NOMA operation.

In another aspect, more than one PSFCH for more than one UE may be communicated in a single PRB, and a first PSFCH associated with a first UE may be designed to be separated from a second PSFCH associated with a second UE. Here, the first PSFCH received by the first UE may be separated from the second PSFCH for the second UE in at least one of a power domain, a coding domain, or a frequency domain. In one example, the first PSFCH and the second PSFCH may be separated in the coding domain may use a cyclic shift, where the select shift may be based on a set of parameters. In another example, the first PSFCH and the second PSFCH may be separated in the frequency domain where the first PSFCH and the second PSFCH may be assigned a different PRBs. In another example, the first PSFCH and the second PSFCH may be separated in the power domain where each UE will set the power control parameters (e.g., P_{O} or A) to have different values for the first UE and the second UE, so that the first UE and the second UE may perform a cancellation.

In some aspects, the PSFCH may be transmitted based on grant-free NOMA operation. In one example, in response to the PSSCH transmitted and received on the grant-free NOMA operation, the Rx SL UE may be configured to transmit the PSFCH on the grant-free NOMA operation. In another example, in response to the PSSCH transmitted and received on a grant-based operation, the Rx SL UE may be configured to transmit the grant-free PSFCH on NOMA operation.

In one aspect, a single PSFCH's PRB may carry one or more feedback transmissions (e.g., PSFCH), where different power control configurations may be assigned to different UEs. That is, the UEs may be separated in the power domain, and each UE may be set with different configurations (e.g., P_{O} or A) having different values at the receiving UE of the PSFCH, so that the receiving UE of the PSFCH may perform the cancellation to separate the PSFCHs in the single PRB.

In another aspect, on RP level, the network node may assign a different set of PRBs to be used for different UEs performing the NOMA operation, and the mapping between slot index and sub-channel index (or size) may be not limited to a 1-to-1 match. For example, two slots of RB may be configured to end up with the same set of PRB s

In another aspect, a set of parameters used to decouple multiple PSFCHs for different UEs on the NOMA operation may include at least one of the source ID of the Tx SL UE, the destination ID of the Tx SL UE, the zone ID associated with the Tx SL UE, a data priority, a quality of service (QoS), one or more configured IDs associated with the set of parameters for determining the PRB of the PSFCH, a PSSCH DMRS configuration parameters including the DMRS scrambling ID, set of PSCCH DMRS patterns/configurations per the RP, a PSCCH DMRS configuration parameters including the DMRS scrambling ID, FD-OCC index, set of PSSCH DMRS patterns/configurations per RP, or Other parameters such as Redundancy version (RV) index, number of code block groups (CBGs) or code blocks (CBs) in the transmission, or a function of CRC of the PSCCH or PSSCH.

In some aspects, the timing configuration including a minimum time gap between the receiving the PSSCH and transmitting the PSFCH. In one example, for the grant-based operation, a timing parameter (e.g., MinTimeGapPSFCH) may be configured for the UE to send the HARQ-ACK (e.g., the PSFCH) of the PSSCH signal, where the UE may use the next available PSFCH resource after a number of slots indicated by the timing parameter to send the feedback. For example, the parameter MinTimeGapPSFCH may indicate 2 slots, and the UE may use the next available PSFCH PRBs after 2 slots from receiving the PSSCH.

For the Rx SL UE to perform the grant-free NOMA, the Rx SL UE may be configured with a longer processing time than UEs on grant-based operation. That is, the processing time for the grant-free NOMA operation may be greater than the grant-based operation. Accordingly, for the Rx SL UE on the grant-free NOMA operation, a dedicated time parameter may be configured for the timeline between receiving the PSSCH to transmitting the PSFCH. In one example, the dedicated time parameter may be configured based on a number of UEs involved in the grant-free NOMA operation. Here, the number of TBs that the Rx SL UE may process may be based on the number of UEs involved in the grant-free NOMA operation, and the processing time for the Rx SL UE may be based on the number of TBs for the Rx SL UE to process. Therefore, the processing time for the Rx SL UE may be increased based on the number of UEs involved in the grant-free NOMA operation.

In one aspect, a dedicated timing parameter indicating the min time gap for grant-free NOMA (e.g., MinTimeGapPSFCH_NOMA) for the UE to send HARQ-ACK (e.g., PSFCH) of the PSSCH signal, where the UE uses the next available PSFCH resource after the number slots indicated by the timing parameter to send the feedback. For example, the parameter MinTimeGapPSFCH_NOMA may indicate more than 2 slots. The parameter MinTimeGapPSFCH_NOMA may be selected from a list of time gaps based on the number of UEs to involved in the grant-free NOMA operation.

In another aspect, a default value of MinTimeGapPSFCH_NOMA (e.g., based on an average/max processing time per UE in the grant-free NOMA operation) may be configured, and the network node, the PLC, or the primary UE may determine the time needed for a UE to determine the HARQ-ACK of the involved UEs. In another aspect, the UE may send a table or bitmap showing the MinTimeGapPSFCH_NOMA based on the number of UEs.

In another aspect, the number of Tx SL UEs involved in the grant-free NOMA operation may not be known to each Tx SL UE. Accordingly, the Rx SL UE may signal the Tx SL UE on the grant-free NOMA operation. In one example, the Rx SL UE may indicate the timing parameter (e.g., MinTimeGapPSFCH_NOMA) associated with the number of the Tx SL UEs involved in the grant-free NOMA operation or a maximum value of the timing parameter to the Tx SL UE. In another example, the Rx SL UE may indicate the number of the Tx SL UEs involved in the grant-free NOMA operation, and based on the nominal values or define tables or bitmaps indicating the timing parameter based on the number of Tx SL UEs involved in the NOMA operation, each of the Tx SL UEs may determine the time to receive the feedback (e.g., the PSFCH) based on the PSSCH transmitted to the Rx SL UE. Here, the time may change from one Tx SL UE to another based on an order of decoding at Rx SL UEs (e.g., based on different processing time).

In another aspect, the number of UEs involved in the grant-free NOMA operation may be limited to a maximum number. Because the processing time of the PSSCH on the Rx SL UE side may increase based on the number of Tx SL UE involved in the grant-free NOMA operation, a maximum number of Tx SL UEs involved in the grant-free NOMA operation may be configured to limit the processing delay. Based on the maximum number of Tx SL UEs involved in the grant-free NOMA operation a max value of the timing parameter (e.g., MinTimeGapPSFCH_NOMA) may be determined and the maximum value of the timing parameter may be configured per RP.

In one example, the HARQ-ACK bits (e.g., via PSFCH) for all the Tx SL UEs may be transmitted after the maximum value of the timing parameter. That is, the maximum value of the timing parameter may be configured as the timing parameter, and the Tx SL UEs involved in the grant-free NOMA operation may receive the PSFCH after the maximum value of the timing parameter. In another example, the HARQ-ACK bits may be transmitted based on the order of decoding. For example, the Tx SL UE that transmits the PSSCH with the highest P_{O} may be decoded first, and based on the order of decoding, the HARQ-ACK bit for the Tx SL UE with the highest P_{O} may be generated and reported before the maximum value of the timing parameter (e.g., MinTimeGapPSFCH_NOMA). The Rx SL UE may indicate its ability to report each decoded bit to its Tx SL UE and indicate the order of decoding and/or reporting for each Tx SLUE.

In another aspect, the maximum number of UEs to transmit the PSSCH using the grant-free NOMA operating to the Rx SL UE may be configured per RP, and based on the Rx SL UEs capability of decoding, the actual number of UEs at a certain time may be controlled by the Rx SL UE. That is, the maximum number of UEs to transmit the PSSCH based on the grant-free NOMA operation may be configured as the maximum limit, and the Rx SL UE may configure the number of Tx SL UE to transmit the PSSCH on the grant-free NOMA operation may be dynamically configured based on the capability (e.g., the processing capability) of the Rx SL UE.

In another aspect, using the at least one of the SCI-1 or the SCI-2, the Tx SL UE may indicate whether the corresponding transmission based on the grant-free NOMA operation or the grant-based operation. Based on the indication of the grant-free NOMA operation in the SCI-1 or the SCI-2, the Rx SL UE may identify the PRBs used for NOMA in case different sets of PRBs are used for reporting PSFCH on the NOMA operation and the non-NOMA operation. The Rx SL UE, the network node, or the PLC may send an indication in at least one of the L1 signal, the L2 signal, or the L3 signal before the grant-free NOMA transmission to indicate to other UEs whether the corresponding sidelink transmission is on the grant-free NOMA or not, and notify the associated processing time.

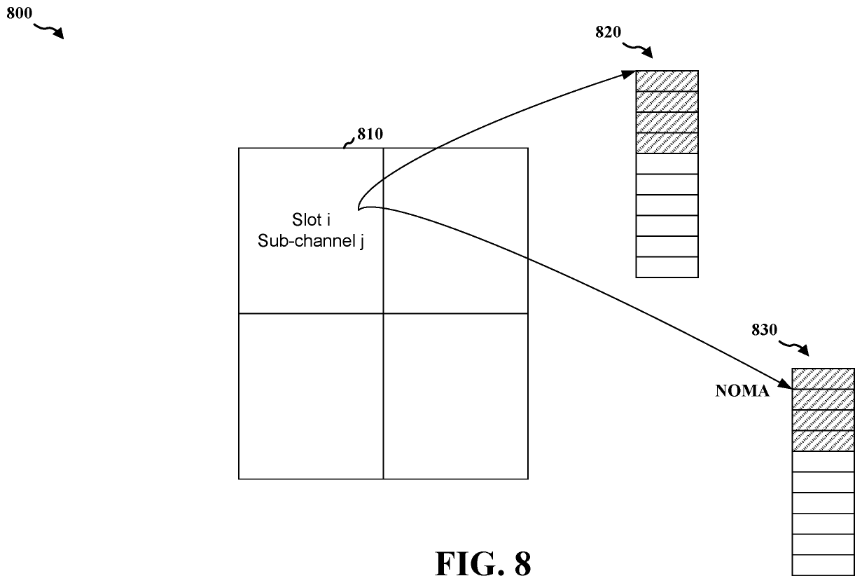

FIG. 8 is an example 800 of assigning PSFCH resources in sidelink communication. The example 800 may include a first set of PRBs 810 for the PSSCH, a second set of PRBs 820 assigned for the PSFCH, and a third set of PRBs 830, and illustrate how the UE may select the PRB among the second set of PRBs 820 or the third set of PRBs 830 for transmitting the PSFCH carrying the verification bits. The mapping between the PSSCH and the PSFCH may be based on at least one of 1) the starting sub-channel of the PSSCH, 2) the slot containing the PSSCH, 3) the source ID, or 4) the destination ID.

The network node may indicate a certain set of PSFCH PRBs to be used for NOMA and other set for regular transmissions. Here, the second set of PRBs 820 may be assigned as the PSFCH PRBs for grant-based operation, and the third set of PRBs 830 may be assigned as the PSFCH PRBs for grant-free NOMA operation. Accordingly, for the same configurations (e.g., slot index, sub-channel index), different sets of PRBs that the source UE (e.g., the Tx SL UE) and the destination UE (e.g., the Rx SL UE) may use for the feedback using the grant-free NOMA operation or the grant-based operation. Accordingly, a risk of the collision between the grant-free NOMA and grant-based NOMA may be avoided. Assigning different sets of PRBs for communicating PSFCHs associated with the grant-free NOMA operation and the grant-based operation may be useful because the processing time may be different.

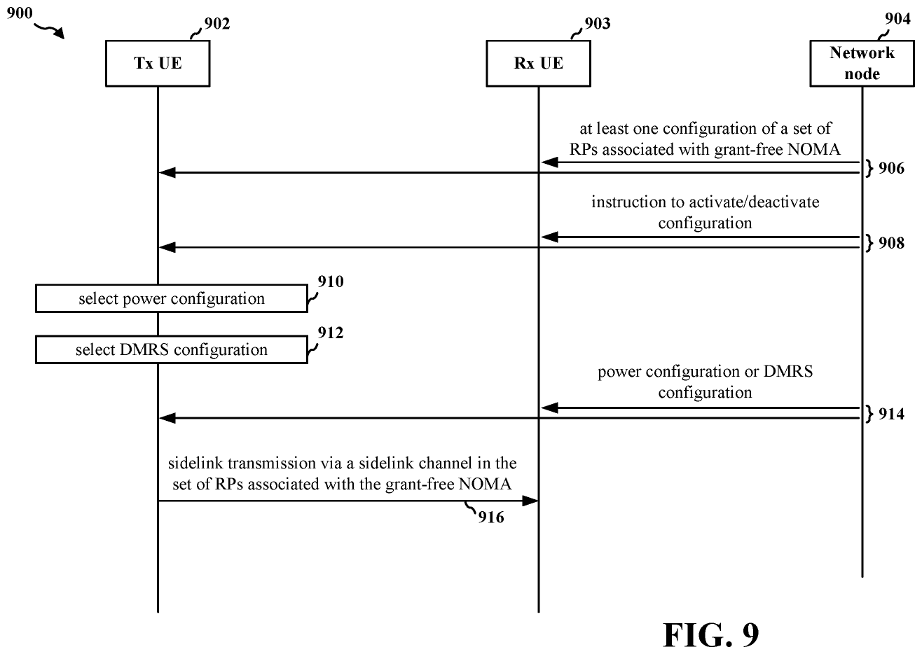

FIG. 9 is a call-flow diagram 900 of a method of wireless communication. The call-flow diagram 900 may include a Tx UE 902, a Rx UE 903, and a network node 904. Here, the network node 904 may be at least one of a gNB, a PLC, or a primary UE. The Tx UE 902 and the Rx UE 903 may be configured to perform the sidelink communicate on a grant-free NOMA operation. The grant-free NOMA for the sidelink communication may be configured by the network node 904.

At 906, the network node 904 may transmit at least one configuration of a set of RPs to a plurality of UEs including the Tx UE 902 and the Rx UE 903, the set of RPs being associated with grant-free NOMA for sidelink communication. The Tx UE 902 may obtain at least one configuration of a set of RPs from a network node 904, the set of RPs being associated with grant-free NOMA for sidelink communication.

In one aspect, the at least one configuration of the set of RPs may indicate at least one sub-RP assigned for the grant-free NOMA for the sidelink communication. That is, instead of assigning a whole RP, at least one sub-RP may be assigned for the grant-free operation.

In another aspect, the at least one configuration of the set of RPs may include dedicated configured grants shared by a plurality of UEs including the Tx UE 902 to perform grant-free sidelink communication. That is, instead of assigning certain RPs, network node 904 can assign certain configured grants for grant-free operation, which may be shared among a set of UEs, to use the grant-free NOMA operation. In cased of the mode 1 SL resource allocation, the network node 904 may transmit a dedicated configured grants and instruct a set of UEs to share the set of RPs for the grant-free NOMA operation. In one example, the configured grants of the set of RPs for the grant-free NOMA operation may be valid until receiving new configured grants. In another example, the configured grants of the set of RPs for the grant-free NOMA operation may be valid for a time period.

In another aspect, the at least one configuration of the set of RPs may include a set of FD-OCC associated with a PSCCH, and an oversampling factor may be applied to the set of FD-OCC. That is, the at least one configuration of the set of RPs may include a set of FD-OCCs and DMRS configuration IDs associated with at least one of a PSCCH or a PSSCH. Based on a matrix size N=3 and the oversampling factor of O, The FD-OCC may separate more Tx UEs including the Tx UE 902, at the cost of more channel estimations. To support the dedicated FD-OCC with the oversampling factor of O, the Rx SL UEs including the Rx UE 903 may need to perform increased number of channel estimation, but may separate one UE from another. For example, the oversampling factor may be “O” the matrix size of N=3. The number of FD-OCC may extend to 3*O=12. If the oversampling factor O is 4, the following set of DFT vectors may be repetition of a first set of the FD-OCC identified with index of 0, 4, 8, a second set with 1, 5, 9, a third set with 2, 6, 10, and a fourth set with 3, 7, 11.

$$F = {DFT}_{ON \vert N columns} = {[ \begin{matrix}1 & 1 & 1 & … & 1 \\ 1 & {e}^{\frac{j 2 π}{ON}} & {e}^{\frac{j 2 π ( 2 )}{ON}} & … & {e}^{\frac{j 2 π ( N - 1 )}{ON}} \\ 1 & {e}^{\frac{j 2 π ( 2 )}{ON}} & {e}^{\frac{j 2 π ( 4 )}{ON}} & … & {e}^{\frac{j 2 π ( 2 ) ( N - 1 )}{ON}} \\ ⋮ & ⋮ & ⋮ & ⋮ & ⋮ \\ 1 & {e}^{\frac{j 2 π ( ON - 1 )}{ON}} & {e}^{\frac{j 2 π ( ON - 1 ) ( 2 )}{ON}} & … & {e}^{\frac{j 2 π ( ON - 1 ) ( N - 1 )}{ON}}\end{matrix} ]}_{ON \times N}$$

At 908, the network node 904 may transmit an instruction to activate or deactivate the NOMA for the sidelink communication based on at least one of a cast type, a data priority, or a QoS. The Tx UE 902 may receive an instruction to activate or deactivate the NOMA for the sidelink communication based on at least one of a cast type, a data priority, or a QoS. That is, the grant-free NOMA operation may be enabled or disabled for some type of cast or priority and/or QoS of the data. Here, the cast type may indicate whether the SL communication is a multicast (e.g., broadcasting) transmission or a unicast (e.g., point-to-point communication) transmission.

In one aspect, the instruction to activate or deactivate the NOMA may be received via at least one of a L1 signal, a L2 signal, or a L3 signal The instruction to activate or deactivate the NOMA is received via at least one of a L1 signal, a L2 signal, or a L3 signal.

In another aspect, the instruction to activate or deactivate the NOMA may include an indication of a timer, and the grant-free NOMA is activated or deactivated until an expiration of the timer. That is, the activation of the at least one configuration of a set of RPs associated with the grant-free NOMA operation may be based on the timer.

At 910, the Tx UE 902 may select a power configuration associated with one or more of at least one PSCCH or at least one PSSCH on the set of RPs, where the power configuration is selected from a set of applicable power configurations. That is, the UEs including the Tx UE 902 may be separated in the power domain, and the Tx UE 902 may select power configurations for transmitting the PSCCH or the PSSCH for the set of RPs from a set of available power configurations. The power configurations may include at least one power delta (e.g., A) or a P_{O}. In one aspect, a set of available power configurations may be configured for the set of RPs, and each UE may select the power configuration from the set of available power configurations per cast. For example, the Tx UE 902 may select the P_{O} parameter from a set of available power configurations and determine the transmission power to transmit its data.

In one aspect, the power configuration may be selected based on at least one of a source ID, a destination ID, a zone ID, a data priority, a QoS, a PSCCH CRC, one or more configured IDs for randomization, or a cast type. In one example, each UE may select the power configuration based on at least one of a source ID of the Tx UE 902, a destination ID of the Tx UE 902, a zone ID associated with the Tx UE 902, a data priority, a QoS, one or more configured IDs for randomization, or a cast type. In another example, the SL channel may be a PSSCH, and the Tx UE 902 may select the power configuration based on the PSCCH CRC, similar to selecting the PSSCH DMRS sequence based on a function of the PSCCH CRC. For example, each UE may select a random P_{O} from a plurality of P_{O}s or select the Δ_{NOMA} based on the source ID. Accordingly, the SL transmissions on the grant-free NOMA operation may be separated in the power domain based on the power control configurations for decoding (e.g., for interference cancellation). The UE separation may be based on a function of distance and pathloss where each distance and/or pathloss may have its own P_{O} or power delta (e.g., Δ) configurations.

At 912, the Tx UE 902 may select a DMRS configuration associated with one or more or at least one PSCCH or at least one PSSCH on the set of RPs, where the DMRS configuration is selected from a set of applicable DMRS configurations. That is, different DMRS may be used to estimate each UE's channels at the common receiver, and the Tx UE 902 may select the PSCCH DMRS configuration (e.g., the DMRS pattern or the DMRS configuration) and the PSSCH DMRS configuration from a plurality of configurations per the set of RPs.

In one aspect, the DMRS configuration may be selected based on at least one of a source ID, a destination ID, a zone ID, a data priority, a QoS, a CRC of SCI-1, one or more configured IDs for randomization, or a cast type. That is, the selection of the PSCCH DMRS configuration and the PSSCH DMRS configuration may be based at least one of a source ID of the Tx UE 902, a destination ID of the Tx UE 902, a zone ID associated with the Tx UE 902, a data priority, a QoS (adding another dimension to separate the UEs), the CRC of the SCI-1, a configured ID to be used for randomization, or the cast type. Here, the one or more configured IDs for randomization may be configured using the RRC message, the MAC-CE, an SL wakeup signal (WUS), or a dedicated PSSCH.

In another aspect, the DMRS configuration may include a DMRS scrambling ID determined based on at least one of a source ID, a destination ID, a zone ID, a data priority, a QoS, a CRC of SCI-1, one or more configured IDs for randomization, or a cast type. That is, the DMRS scrambling ID may be determined as a function of the above-mentioned parameters to select different DMRS configurations for each of the UE. For example, the DMRS scrambling ID may be selected based on the source ID of the Tx UE 902 or the destination ID of the Rx UE 903.

At 914, the network node 904 may transmit a power configuration or a DMRS configuration associated with at least one PSCCH or at least one PSSCH on the set of RPs. The Tx UE 902 may receive a power configuration or a DMRS configuration associated with at least one PSCCH or at least one PSSCH on the set of RPs. That is, in case of the mode 1 SL resource allocation that the network node 904, PLC, or primary UE may control the configurations, and the network node 904, the PLC, or the primary UE may assign separate configurations associated with the grant-free NOMA (e.g., power configuration, FD-OCC, DMRS IDs, etc.) to control the configurations.

At 916, the Tx UE 902 may transmit a sidelink transmission via a sidelink channel to at least one other UE (e.g., the Rx UE 903) in the set of RPs associated with the grant-free NOMA based on the at least one configuration of the set of RPs.

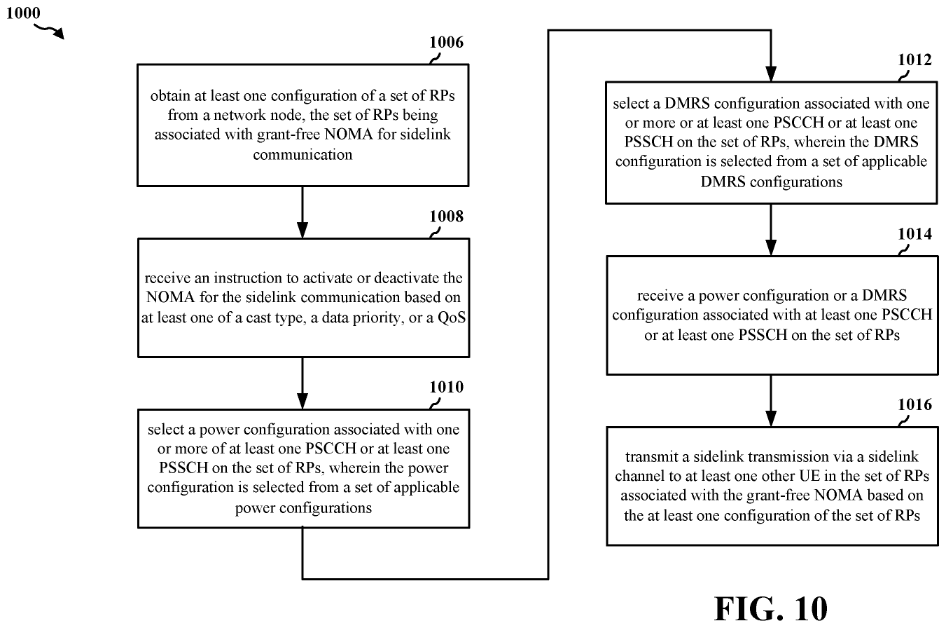

FIG. 10 is a flowchart 1000 of a method of wireless communication. The method may be performed by a UE (e.g., the UE 104, Tx UE 902, the apparatus 1904). Here, the UE may be a Tx SL UE. The UE and a Rx UE may be configured to perform the sidelink communicate on a grant-free NOMA operation. The grant-free NOMA for the sidelink communication may be configured by the network node. Here, the network node may be at least one of a gNB, a PLC, or a primary UE.

At 1006, the UE may obtain at least one configuration of a set of RPs from a network node, the set of RPs being associated with grant-free NOMA for sidelink communication. For example, at 906, the Tx UE 902 may obtain at least one configuration of a set of RPs from a network node 904, the set of RPs being associated with grant-free NOMA for sidelink communication. Furthermore, 1006 may be performed by a NOMA SL component 198.

In one aspect, the at least one configuration of the set of RPs may indicate at least one sub-RP assigned for the grant-free NOMA for the sidelink communication. That is, instead of assigning a whole RP, at least one sub-RP may be assigned for the grant-free operation.

In another aspect, the at least one configuration of the set of RPs may include dedicated configured grants shared by a plurality of UEs including the UE to perform grant-free sidelink communication. That is, instead of assigning certain RPs, network node can assign certain configured grants for grant-free operation, which may be shared among a set of UEs, to use the grant-free NOMA operation. In cased of the mode 1 SL resource allocation, the network node may transmit dedicated configured grants and instruct a set of UEs to share the set of RPs for the grant-free NOMA operation. In one example, the configured grants of the set of RPs for the grant-free NOMA operation may be valid until receiving new configured grants. In another example, the configured grants of the set of RPs for the grant-free NOMA operation may be valid for a time period.

In another aspect, the at least one configuration of the set of RPs may include a set of FD-OCC associated with a PSCCH, and an oversampling factor may be applied to the set of FD-OCC. That is, the at least one configuration of the set of RPs may include a set of FD-OCCs and DMRS configuration IDs associated with at least one of a PSCCH or a PSSCH. Based on a matrix size N=3 and the oversampling factor of O, The FD-OCC may separate more Tx UEs including the UE, at the cost of more channel estimations. To support the dedicated FD-OCC with the oversampling factor of O, the Rx SL UEs including the Rx UE may need to perform increased number of channel estimation, but may separate one UE from another. For example, the oversampling factor may be “O” the matrix size of N=3. The number of FD-OCC may extend to 3*O=12. If the oversampling factor O is 4, the following set of DFT vectors may be repetition of a first set of the FD-OCC identified with index of 0, 4, 8, a second set with 1, 5, 9, a third set with 2, 6, 10, and a fourth set with 3, 7, 11.

$$F = {DFT}_{ON \vert N columns} = {[ \begin{matrix}1 & 1 & 1 & … & 1 \\ 1 & {e}^{\frac{j 2 π}{ON}} & {e}^{\frac{j 2 π ( 2 )}{ON}} & … & {e}^{\frac{j 2 π ( N - 1 )}{ON}} \\ 1 & {e}^{\frac{j 2 π ( 2 )}{ON}} & {e}^{\frac{j 2 π ( 4 )}{ON}} & … & {e}^{\frac{j 2 π ( 2 ) ( N - 1 )}{ON}} \\ ⋮ & ⋮ & ⋮ & ⋮ & ⋮ \\ 1 & {e}^{\frac{j 2 π ( ON - 1 )}{ON}} & {e}^{\frac{j 2 π ( ON - 1 ) ( 2 )}{ON}} & … & {e}^{\frac{j 2 π ( ON - 1 ) ( N - 1 )}{ON}}\end{matrix} ]}_{ON \times N}$$

At 1008, the UE may receive an instruction to activate or deactivate the NOMA for the sidelink communication based on at least one of a cast type, a data priority, or a QoS. That is, the grant-free NOMA operation may be enabled or disabled for some type of cast or priority and/or QoS of the data. Here, the cast type may indicate whether the SL communication is a multicast (e.g., broadcasting) transmission or a unicast (e.g., point-to-point communication) transmission. For example, at 908, the Tx UE 902 may receive an instruction to activate or deactivate the NOMA for the sidelink communication based on at least one of a cast type, a data priority, or a QoS. Furthermore, 1008 may be performed by the NOMA SL component 198.

In one aspect, the instruction to activate or deactivate the NOMA may be received via at least one of a L1 signal, a L2 signal, or a L3 signal The instruction to activate or deactivate the NOMA is received via at least one of a L1 signal, a L2 signal, or a L3 signal.

In another aspect, the instruction to activate or deactivate the NOMA may include an indication of a timer, and the grant-free NOMA is activated or deactivated until an expiration of the timer. That is, the activation of the at least one configuration of a set of RPs associated with the grant-free NOMA operation may be based on the timer.

At 1010, the UE may select a power configuration associated with one or more of at least one PSCCH or at least one PSSCH on the set of RPs, where the power configuration is selected from a set of applicable power configurations. That is, the UEs including the UE may be separated in the power domain, and the UE may select power configurations for transmitting the PSCCH or the PSSCH for the set of RPs from a set of available power configurations. The power configurations may include at least one power delta (e.g., Δ) or a P_{O}. In one aspect, a set of available power configurations may be configured for the set of RPs, and each UE may select the power configuration from the set of available power configurations per cast. For example, the UE may select the P_{O} parameter from a set of available power configurations and determine the transmission power to transmit its data. For example, at 910, the Tx UE 902 may select a power configuration associated with one or more of at least one PSCCH or at least one PSSCH on the set of RPs, where the power configuration is selected from a set of applicable power configurations. Furthermore, 1010 may be performed by the NOMA SL component 198.

At 1012, the UE may select a DMRS configuration associated with one or more or at least one PSCCH or at least one PSSCH on the set of RPs, where the DMRS configuration is selected from a set of applicable DMRS configurations. That is, different DMRS may be used to estimate each UE's channels at the common receiver, and the UE may select the PSCCH DMRS configuration (e.g., the DMRS pattern or the DMRS configuration) and the PSSCH DMRS configuration from a plurality of configurations per the set of RPs. For example, at 912, the Tx UE 902 may select a DMRS configuration associated with one or more or at least one PSCCH or at least one PSSCH on the set of RPs, where the DMRS configuration is selected from a set of applicable DMRS configurations. Furthermore, 1012 may be performed by the NOMA SL component 198.

In one aspect, the DMRS configuration may be selected based on at least one of a source ID, a destination ID, a zone ID, a data priority, a QoS, a CRC of SCI-1, one or more configured IDs for randomization, or a cast type. That is, the selection of the PSCCH DMRS configuration and the PSSCH DMRS configuration may be based at least one of a source ID of the UE, a destination ID of the UE, a zone ID associated with the UE, a data priority, a QoS (adding another dimension to separate the UEs), the CRC of the SCI-1, a configured ID to be used for randomization, or the cast type. Here, the one or more configured IDs for randomization may be configured using the RRC message, the MAC-CE, an SL wakeup signal (WUS), or a dedicated PSSCH.

In another aspect, the DMRS configuration may include a DMRS scrambling ID determined based on at least one of a source ID, a destination ID, a zone ID, a data priority, a QoS, a CRC of SCI-1, one or more configured IDs for randomization, or a cast type. That is, the DMRS scrambling ID may be determined as a function of the above-mentioned parameters to select different DMRS configurations for each of the UE. For example, the DMRS scrambling ID may be selected based on the source ID of the UE or the destination ID of the Rx UE.

At 1014, the UE may receive a power configuration or a DMRS configuration associated with at least one PSCCH or at least one PSSCH on the set of RPs. That is, in case of the mode 1 SL resource allocation that the network node, PLC, or primary UE may control the configurations, and the network node, the PLC, or the primary UE may assign separate configurations associated with the grant-free NOMA (e.g., power configuration, FD-OCC, DMRS IDs, etc.) to control the configurations. For example, at 914, the Tx UE 902 may receive a power configuration or a DMRS configuration associated with at least one PSCCH or at least one PSSCH on the set of RPs. Furthermore, 1014 may be performed by the NOMA SL component 198.

At 1016, the UE may transmit a sidelink transmission via a sidelink channel to at least one other UE (e.g., the Rx UE) in the set of RPs associated with the grant-free NOMA based on the at least one configuration of the set of RPs. For example, at 916, the Tx UE 902 may transmit a sidelink transmission via a sidelink channel to at least one other UE (e.g., the Rx UE 903) in the set of RPs associated with the grant-free NOMA based on the at least one configuration of the set of RPs. Furthermore, 1016 may be performed by the NOMA SL component 198.

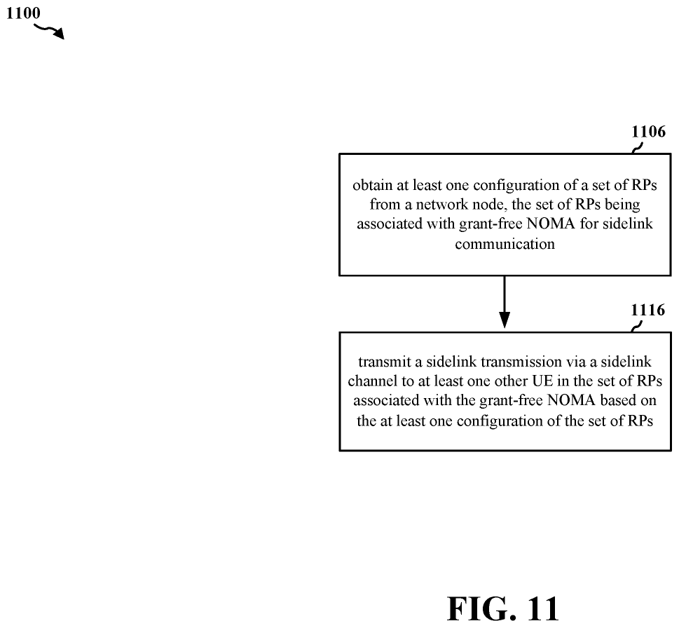

FIG. 11 is a flowchart 1100 of a method of wireless communication. The method may be performed by a UE (e.g., the UE 104, Tx UE 902, the apparatus 1904). Here, the UE may be a Tx SL UE. The UE and a Rx UE may be configured to perform the sidelink communicate on a grant-free NOMA operation. The grant-free NOMA for the sidelink communication may be configured by the network node. Here, the network node may be at least one of a gNB, a PLC, or a primary UE.

At 1106, the UE may obtain at least one configuration of a set of RPs from a network node, the set of RPs being associated with grant-free NOMA for sidelink communication. For example, at 906, the Tx UE 902 may obtain at least one configuration of a set of RPs from a network node 904, the set of RPs being associated with grant-free NOMA for sidelink communication. Furthermore, 1106 may be performed by a NOMA SL component 198.

In one aspect, the at least one configuration of the set of RPs may indicate at least one sub-RP assigned for the grant-free NOMA for the sidelink communication. That is, instead of assigning a whole RP, at least one sub-RP may be assigned for the grant-free operation.

In another aspect, the at least one configuration of the set of RPs may include dedicated configured grants shared by a plurality of UEs including the UE to perform grant-free sidelink communication. That is, instead of assigning certain RPs, network node can assign certain configured grants for grant-free operation, which may be shared among a set of UEs, to use the grant-free NOMA operation. In cased of the mode 1 SL resource allocation, the network node may transmit dedicated configured grants and instruct a set of UEs to share the set of RPs for the grant-free NOMA operation. In one example, the configured grants of the set of RPs for the grant-free NOMA operation may be valid until receiving new configured grants. In another example, the configured grants of the set of RPs for the grant-free NOMA operation may be valid for a time period.

In another aspect, the at least one configuration of the set of RPs may include a set of FD-OCC associated with a PSCCH, and an oversampling factor may be applied to the set of FD-OCC. That is, the at least one configuration of the set of RPs may include a set of FD-OCCs and DMRS configuration IDs associated with at least one of a PSCCH or a PSSCH. Based on a matrix size N=3 and the oversampling factor of O, The FD-OCC may separate more Tx UEs including the UE, at the cost of more channel estimations. To support the dedicated FD-OCC with the oversampling factor of O, the Rx SL UEs including the Rx UE may need to perform increased number of channel estimation, but may separate one UE from another. For example, the oversampling factor may be “O” the matrix size of N=3. The number of FD-OCC may extend to 3*O=12. If the oversampling factor O is 4, the following set of DFT vectors may be repetition of a first set of the FD-OCC identified with index of 0, 4, 8, a second set with 1, 5, 9, a third set with 2, 6, 11, and a fourth set with 3, 7, 11.

$$F = {DFT}_{ON \vert N columns} = {[ \begin{matrix}1 & 1 & 1 & … & 1 \\ 1 & {e}^{\frac{j 2 π}{ON}} & {e}^{\frac{j 2 π ( 2 )}{ON}} & … & {e}^{\frac{j 2 π ( N - 1 )}{ON}} \\ 1 & {e}^{\frac{j 2 π ( 2 )}{ON}} & {e}^{\frac{j 2 π ( 4 )}{ON}} & … & {e}^{\frac{j 2 π ( 2 ) ( N - 1 )}{ON}} \\ ⋮ & ⋮ & ⋮ & ⋮ & ⋮ \\ 1 & {e}^{\frac{j 2 π ( ON - 1 )}{ON}} & {e}^{\frac{j 2 π ( ON - 1 ) ( 2 )}{ON}} & … & {e}^{\frac{j 2 π ( ON - 1 ) ( N - 1 )}{ON}}\end{matrix} ]}_{ON \times N}$$

At 1116, the UE may transmit a sidelink transmission via a sidelink channel to at least one other UE (e.g., the Rx UE) in the set of RPs associated with the grant-free NOMA based on the at least one configuration of the set of RPs. For example, at 916, the Tx UE 902 may transmit a sidelink transmission via a sidelink channel to at least one other UE (e.g., the Rx UE 903) in the set of RPs associated with the grant-free NOMA based on the at least one configuration of the set of RPs. Furthermore, 1116 may be performed by the NOMA SL component 198.

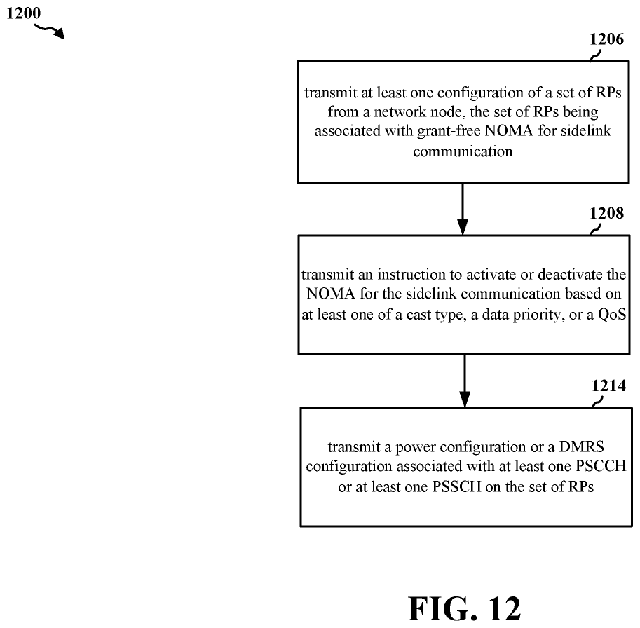

FIG. 12 is a flowchart 1200 of a method of wireless communication. The method may be performed by a network node (e.g., the base station 102, the network node 904, the network entity 2002). Here, the network node may be at least one of a gNB, a PLC, or a primary UE. A Tx UE and a Rx UE may be configured to perform the sidelink communicate on a grant-free NOMA operation. The grant-free NOMA for the sidelink communication may be configured by the network node.

At 1206, the network node may transmit at least one configuration of a set of RPs to a plurality of UEs including the Tx UE and the Rx UE, the set of RPs being associated with grant-free NOMA for sidelink communication. For example, at 906, the network node 904 may transmit at least one configuration of a set of RPs to a plurality of UEs including the Tx UE 902 and the Rx UE 903, the set of RPs being associated with grant-free NOMA for sidelink communication. Furthermore, 1206 may be performed by a NOMA SL configuring component 199.

In one aspect, the at least one configuration of the set of RPs may indicate at least one sub-RP assigned for the grant-free NOMA for the sidelink communication. That is, instead of assigning a whole RP, at least one sub-RP may be assigned for the grant-free operation.

In another aspect, the at least one configuration of the set of RPs may include dedicated configured grants shared by a plurality of UEs including the UE to perform grant-free sidelink communication. That is, instead of assigning certain RPs, network node can assign certain configured grants for grant-free operation, which may be shared among a set of UEs, to use the grant-free NOMA operation. In cased of the mode 1 SL resource allocation, the network node may transmit dedicated configured grants and instruct a set of UEs to share the set of RPs for the grant-free NOMA operation. In one example, the configured grants of the set of RPs for the grant-free NOMA operation may be valid until receiving new configured grants. In another example, the configured grants of the set of RPs for the grant-free NOMA operation may be valid for a time period.

In another aspect, the at least one configuration of the set of RPs may include a set of FD-OCC associated with a PSCCH, and an oversampling factor may be applied to the set of FD-OCC. That is, the at least one configuration of the set of RPs may include a set of FD-OCCs and DMRS configuration IDs associated with at least one of a PSCCH or a PSSCH. Based on a matrix size N=3 and the oversampling factor of O, The FD-OCC may separate more Tx UEs including the UE, at the cost of more channel estimations. To support the dedicated FD-OCC with the oversampling factor of O, the Rx SL UEs including the Rx UE may need to perform increased number of channel estimation, but may separate one UE from another. For example, the oversampling factor may be “O” the matrix size of N=3. The number of FD-OCC may extend to 3*O=12. If the oversampling factor O is 4, the following set of DFT vectors may be repetition of a first set of the FD-OCC identified with index of 0, 4, 8, a second set with 1, 5, 9, a third set with 2, 6, 10, and a fourth set with 3, 7, 11.

$$F = {DFT}_{ON \vert N columns} = {[ \begin{matrix}1 & 1 & 1 & … & 1 \\ 1 & {e}^{\frac{j 2 π}{ON}} & {e}^{\frac{j 2 π ( 2 )}{ON}} & … & {e}^{\frac{j 2 π ( N - 1 )}{ON}} \\ 1 & {e}^{\frac{j 2 π ( 2 )}{ON}} & {e}^{\frac{j 2 π ( 4 )}{ON}} & … & {e}^{\frac{j 2 π ( 2 ) ( N - 1 )}{ON}} \\ ⋮ & ⋮ & ⋮ & ⋮ & ⋮ \\ 1 & {e}^{\frac{j 2 π ( ON - 1 )}{ON}} & {e}^{\frac{j 2 π ( ON - 1 ) ( 2 )}{ON}} & … & {e}^{\frac{j 2 π ( ON - 1 ) ( N - 1 )}{ON}}\end{matrix} ]}_{ON \times N}$$

At 1208, the network node may transmit an instruction to activate or deactivate the NOMA for the sidelink communication based on at least one of a cast type, a data priority, or a QoS. That is, the grant-free NOMA operation may be enabled or disabled for some type of cast or priority and/or QoS of the data. Here, the cast type may indicate whether the SL communication is a multicast (e.g., broadcasting) transmission or a unicast (e.g., point-to-point communication) transmission. For example, at 908, the network node 904 may transmit an instruction to activate or deactivate the NOMA for the sidelink communication based on at least one of a cast type, a data priority, or a QoS. Furthermore, 1208 may be performed by the NOMA SL configuring component 199.

In one aspect, the instruction to activate or deactivate the NOMA may be received via at least one of a L1 signal, a L2 signal, or a L3 signal. The instruction to activate or deactivate the NOMA is received via at least one of a L1 signal, a L2 signal, or a L3 signal.

In another aspect, the instruction to activate or deactivate the NOMA may include an indication of a timer, and the grant-free NOMA is activated or deactivated until an expiration of the timer. That is, the activation of the at least one configuration of a set of RPs associated with the grant-free NOMA operation may be based on the timer.

At 1214, the network node may transmit a power configuration or a DMRS configuration associated with at least one PSCCH or at least one PSSCH on the set of RPs. That is, in case of the mode 1 SL resource allocation that the network node, PLC, or primary UE may control the configurations, and the network node, the PLC, or the primary UE may assign separate configurations associated with the grant-free NOMA (e.g., power configuration, FD-OCC, DMRS IDs, etc.) to control the configurations. For example, at 914, the network node 904 may transmit a power configuration or a DMRS configuration associated with at least one PSCCH or at least one PSSCH on the set of RPs. Furthermore, 1214 may be performed by the NOMA SL configuring component 199.

FIG. 12 is a flowchart 1200 of a method of wireless communication. The method may be performed by a network node (e.g., the base station 102, the network node 904, the network entity 2002). Here, the network node may be at least one of a gNB, a PLC, or a primary UE. A Tx UE and a Rx UE may be configured to perform the sidelink communicate on a grant-free NOMA operation. The grant-free NOMA for the sidelink communication may be configured by the network node.

At 1206, the network node may transmit at least one configuration of a set of RPs to a plurality of UEs including the Tx UE and the Rx UE, the set of RPs being associated with grant-free NOMA for sidelink communication. For example, at 906, the network node 904 may transmit at least one configuration of a set of RPs to a plurality of UEs including the Tx UE 902 and the Rx UE 903, the set of RPs being associated with grant-free NOMA for sidelink communication. Furthermore, 1206 may be performed by a NOMA SL configuring component 199.

In one aspect, the at least one configuration of the set of RPs may indicate at least one sub-RP assigned for the grant-free NOMA for the sidelink communication. That is, instead of assigning a whole RP, at least one sub-RP may be assigned for the grant-free operation.

In another aspect, the at least one configuration of the set of RPs may include dedicated configured grants shared by a plurality of UEs including the UE to perform grant-free sidelink communication. That is, instead of assigning certain RPs, network node can assign certain configured grants for grant-free operation, which may be shared among a set of UEs, to use the grant-free NOMA operation. In cased of the mode 1 SL resource allocation, the network node may transmit dedicated configured grants and instruct a set of UEs to share the set of RPs for the grant-free NOMA operation. In one example, the configured grants of the set of RPs for the grant-free NOMA operation may be valid until receiving new configured grants. In another example, the configured grants of the set of RPs for the grant-free NOMA operation may be valid for a time period.

In another aspect, the at least one configuration of the set of RPs may include a set of FD-OCC associated with a PSCCH, and an oversampling factor may be applied to the set of FD-OCC. That is, the at least one configuration of the set of RPs may include a set of FD-OCCs and DMRS configuration IDs associated with at least one of a PSCCH or a PSSCH. Based on a matrix size N=3 and the oversampling factor of O, The FD-OCC may separate more Tx UEs including the UE, at the cost of more channel estimations. To support the dedicated FD-OCC with the oversampling factor of O, the Rx SL UEs including the Rx UE may need to perform increased number of channel estimation, but may separate one UE from another. For example, the oversampling factor may be “O” the matrix size of N=3. The number of FD-OCC may extend to 3*O=12. If the oversampling factor O is 4, the following set of DFT vectors may be repetition of a first set of the FD-OCC identified with index of 0, 4, 8, a second set with 1, 5, 9, a third set with 2, 6, 10, and a fourth set with 3, 7, 11.

$$F = {DFT}_{ON \vert N columns} = {[ \begin{matrix}1 & 1 & 1 & … & 1 \\ 1 & {e}^{\frac{j 2 π}{ON}} & {e}^{\frac{j 2 π ( 2 )}{ON}} & … & {e}^{\frac{j 2 π ( N - 1 )}{ON}} \\ 1 & {e}^{\frac{j 2 π ( 2 )}{ON}} & {e}^{\frac{j 2 π ( 4 )}{ON}} & … & {e}^{\frac{j 2 π ( 2 ) ( N - 1 )}{ON}} \\ ⋮ & ⋮ & ⋮ & ⋮ & ⋮ \\ 1 & {e}^{\frac{j 2 π ( ON - 1 )}{ON}} & {e}^{\frac{j 2 π ( ON - 1 ) ( 2 )}{ON}} & … & {e}^{\frac{j 2 π ( ON - 1 ) ( N - 1 )}{ON}}\end{matrix} ]}_{ON \times N}$$

At 1208, the network node may transmit an instruction to activate or deactivate the NOMA for the sidelink communication based on at least one of a cast type, a data priority, or a QoS. That is, the grant-free NOMA operation may be enabled or disabled for some type of cast or priority and/or QoS of the data. Here, the cast type may indicate whether the SL communication is a multicast (e.g., broadcasting) transmission or a unicast (e.g., point-to-point communication) transmission. For example, at 908, the network node 904 may transmit an instruction to activate or deactivate the NOMA for the sidelink communication based on at least one of a cast type, a data priority, or a QoS. Furthermore, 1208 may be performed by the NOMA SL configuring component 199.

In one aspect, the instruction to activate or deactivate the NOMA may be received via at least one of a L1 signal, a L2 signal, or a L3 signal. The instruction to activate or deactivate the NOMA is received via at least one of a L1 signal, a L2 signal, or a L3 signal.

In another aspect, the instruction to activate or deactivate the NOMA may include an indication of a timer, and the grant-free NOMA is activated or deactivated until an expiration of the timer. That is, the activation of the at least one configuration of a set of RPs associated with the grant-free NOMA operation may be based on the timer.

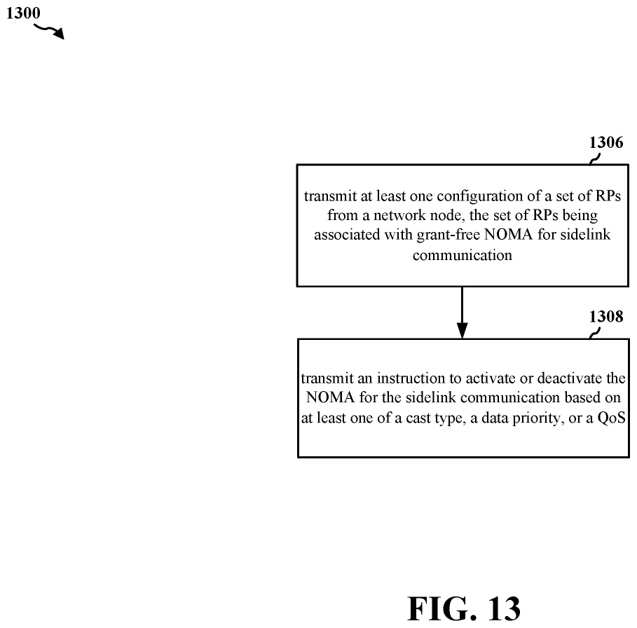

FIG. 13 is a flowchart 1300 of a method of wireless communication. The method may be performed by a network node (e.g., the base station 102, the network node 904, the network entity 2002). Here, the network node may be at least one of a gNB, a PLC, or a primary UE. A Tx UE and a Rx UE may be configured to perform the sidelink communicate on a grant-free NOMA operation. The grant-free NOMA for the sidelink communication may be configured by the network node.

At 1306, the network node may transmit at least one configuration of a set of RPs to a plurality of UEs including the Tx UE and the Rx UE, the set of RPs being associated with grant-free NOMA for sidelink communication. For example, at 906, the network node 904 may transmit at least one configuration of a set of RPs to a plurality of UEs including the Tx UE 902 and the Rx UE 903, the set of RPs being associated with grant-free NOMA for sidelink communication. Furthermore, 1306 may be performed by a NOMA SL configuring component 199.

In one aspect, the at least one configuration of the set of RPs may indicate at least one sub-RP assigned for the grant-free NOMA for the sidelink communication. That is, instead of assigning a whole RP, at least one sub-RP may be assigned for the grant-free operation.

In another aspect, the at least one configuration of the set of RPs may include dedicated configured grants shared by a plurality of UEs including the UE to perform grant-free sidelink communication. That is, instead of assigning certain RPs, network node can assign certain configured grants for grant-free operation, which may be shared among a set of UEs, to use the grant-free NOMA operation. In cased of the mode 1 SL resource allocation, the network node may transmit dedicated configured grants and instruct a set of UEs to share the set of RPs for the grant-free NOMA operation. In one example, the configured grants of the set of RPs for the grant-free NOMA operation may be valid until receiving new configured grants. In another example, the configured grants of the set of RPs for the grant-free NOMA operation may be valid for a time period.

In another aspect, the at least one configuration of the set of RPs may include a set of FD-OCC associated with a PSCCH, and an oversampling factor may be applied to the set of FD-OCC. That is, the at least one configuration of the set of RPs may include a set of FD-OCCs and DMRS configuration IDs associated with at least one of a PSCCH or a PSSCH. Based on a matrix size N=3 and the oversampling factor of O, The FD-OCC may separate more Tx UEs including the UE, at the cost of more channel estimations. To support the dedicated FD-OCC with the oversampling factor of O, the Rx SL UEs including the Rx UE may need to perform increased number of channel estimation, but may separate one UE from another. For example, the oversampling factor may be “O” the matrix size of N=3. The number of FD-OCC may extend to 3*O=12. If the oversampling factor O is 4, the following set of DFT vectors may be repetition of a first set of the FD-OCC identified with index of 0, 4, 8, a second set with 1, 5, 9, a third set with 2, 6, 10, and a fourth set with 3, 7, 11.

$$F = {DFT}_{ON \vert N columns} = {[ \begin{matrix}1 & 1 & 1 & … & 1 \\ 1 & {e}^{\frac{j 2 π}{ON}} & {e}^{\frac{j 2 π ( 2 )}{ON}} & … & {e}^{\frac{j 2 π ( N - 1 )}{ON}} \\ 1 & {e}^{\frac{j 2 π ( 2 )}{ON}} & {e}^{\frac{j 2 π ( 4 )}{ON}} & … & {e}^{\frac{j 2 π ( 2 ) ( N - 1 )}{ON}} \\ ⋮ & ⋮ & ⋮ & ⋮ & ⋮ \\ 1 & {e}^{\frac{j 2 π ( ON - 1 )}{ON}} & {e}^{\frac{j 2 π ( ON - 1 ) ( 2 )}{ON}} & … & {e}^{\frac{j 2 π ( ON - 1 ) ( N - 1 )}{ON}}\end{matrix} ]}_{ON \times N}$$

At 1308, the network node may transmit an instruction to activate or deactivate the NOMA for the sidelink communication based on at least one of a cast type, a data priority, or a QoS. That is, the grant-free NOMA operation may be enabled or disabled for some type of cast or priority and/or QoS of the data. Here, the cast type may indicate whether the SL communication is a multicast (e.g., broadcasting) transmission or a unicast (e.g., point-to-point communication) transmission. For example, at 908, the network node 904 may transmit an instruction to activate or deactivate the NOMA for the sidelink communication based on at least one of a cast type, a data priority, or a QoS. Furthermore, 1308 may be performed by the NOMA SL configuring component 199.

In one aspect, the instruction to activate or deactivate the NOMA may be received via at least one of a L1 signal, a L2 signal, or a L3 signal. The instruction to activate or deactivate the NOMA is received via at least one of a L1 signal, a L2 signal, or a L3 signal.

In another aspect, the instruction to activate or deactivate the NOMA may include an indication of a timer, and the grant-free NOMA is activated or deactivated until an expiration of the timer. That is, the activation of the at least one configuration of a set of RPs associated with the grant-free NOMA operation may be based on the timer.

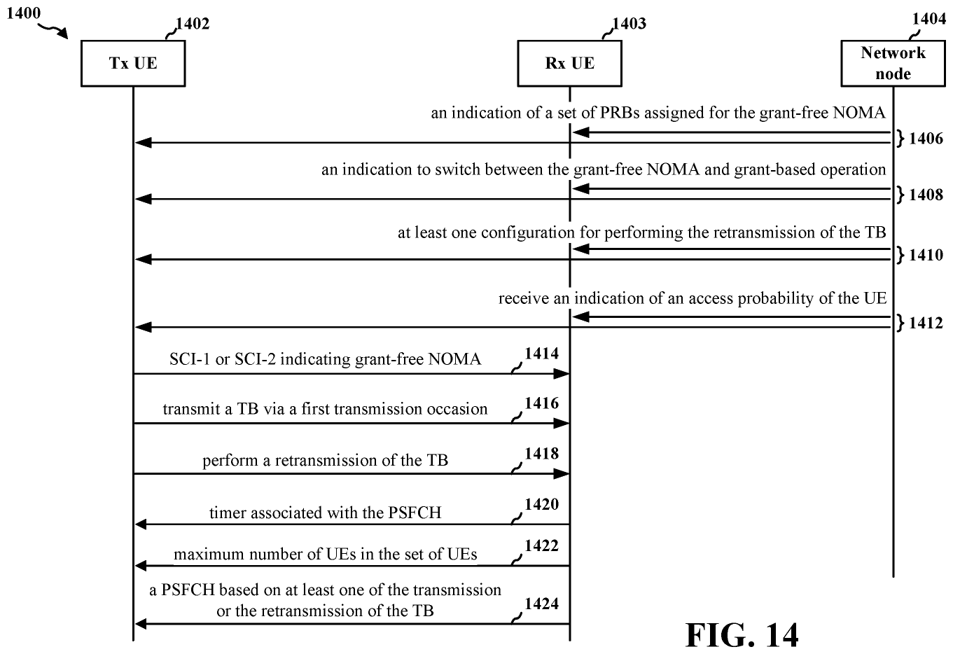

FIG. 14 is a call-flow diagram 1400 of a method of wireless communication. The call-flow diagram 1400 may include a Tx UE 1402, a Rx UE 1403, and a network node 1404. Here, the network node 1404 may be at least one of a gNB, a PLC, or a primary UE. The Tx UE 1402 may be configured with a set of PRBs assigned for the grant-free NOMA, and the Tx UE 1402 may transmit a TB via a first transmission occasion and perform a retransmission of the TB in at least one retransmission occasion. In response to the transmission of the TB, the Rx UE 1403 may transmit the PSFCH on the grant-free NOMA.

At 1406, the Tx UE 1402 may receive an indication of a set of PRBs assigned for the grant-free NOMA, where at least one PRB of the set of PRB is associated with more than one slot of a PSSCH. The Rx UE 1403 may receive an indication of a set of PRBs assigned for the grant-free NOMA, where at least one PRB of the set of PRB is associated with more than one slot of a PSSCH. For example, the network node 1404 may configure the first set of resources, the second set of resources, and the third set of resources for the set of UEs including the Tx UE 1402 and the Rx UE 1403 to perform NOMA sidelink communication. The Tx UE 1402 may reserve the first set of resources for the initial transmission of a TB, and reserve the second set of resources and/or the third set of resources for the retransmission of the TB.

At 1408, the Tx UE 1402 may receive an indication to switch between the grant-free NOMA and grant-based NOMA for the sidelink communication. The Rx UE 1403 may receive an indication to switch between the grant-free NOMA and grant-based NOMA for the sidelink communication.

At 1410, the Tx UE 1402 may obtain at least one configuration for performing the retransmission of the TB. The Rx UE 1403 may obtain at least one configuration for performing the retransmission of the TB. The retransmission pattern regarding which UEs to be selected for each transmission or retransmission occasions may be indicated by the RRC message or the MAC-CE, or transmitted in the L1 indication before the first transmission occasion and be agreed between the set of UEs performing the NOMA and the Rx SL UE.

In some aspects, the at least one configuration may include a power configuration associated with the retransmission of the TB, where the power configuration is based on the subset of Tx UEs. In another aspect, the at least one configuration may include a DMRS configuration associated with the retransmission of the TB, where the DMRS configuration is based on the subset of Tx UEs.

In one aspect, the power control parameters/configurations during each retransmission may be same or different, in part based on a change of the subset of UEs participating the NOMA operation. That is, a power configuration associated with the retransmission of the TB may be based on the subset of UEs configured to perform the retransmission. The second subset of UEs may be configured to perform the second retransmission. Accordingly, the first power control parameter/configurations and the second power control parameter/configurations may be different for the first retransmission and the second retransmission.

At 1412, the Tx UE 1402 may receive an indication of an access probability of the Tx UE 1402 from a network node 1404, where the Tx UE 1402 is selected in the set of Tx set of UEs to perform the transmission of the TB and the subset of Tx set of UEs to perform the retransmission of the TB based on the access probability of the Tx UE. The Rx UE 1403 may receive an indication of an access probability of the Tx UE 1402 from the network node 1404, where the Tx UE 1402 is selected in the set of UEs to perform the transmission of the TB and the subset of UEs to perform the retransmission of the TB based on the access probability of the Tx UE.

At 1414, the Tx UE 1402 may transmit SCI-1 or SCI-2 indicating that the transmission of the TB is associated with the grant-free NOMA. The Rx UE 1403 may receive SCI-1 or SCI-2 indicating that the transmission of the TB is associated with the grant-free NOMA. Based on the indication of the grant-free NOMA operation in the SCI-1 or the SCI-2, the Rx SL UE may identify the PRBs used for NOMA in case different sets of PRBs are used for reporting PSFCH on the NOMA operation and the non-NOMA operation. The Rx SL UE, the network node 1404, or the PLC may send an indication in at least one of the L1 signal, the L2 signal, or the L3 signal before the grant-free NOMA transmission to indicate to other UEs whether the corresponding sidelink transmission is on the grant-free NOMA or not, and notify the associated processing time.

At 1416, the Tx UE 1402 may transmit a TB via a first transmission occasion configured for a set of UEs including the UE, the first transmission occasion being associated with grant-free NOMA for sidelink communication. The Rx UE 1403 may receive a TB from a first UE via a first transmission occasion configured for a set of UEs including the first UE, the first transmission occasion being associated with grant-free NOMA for sidelink communication. Here, the first transmission of a grant (configured or dynamic) may be used by the set of Tx UEs to perform the grant-free NOMA operation.

At 1418, the Tx UE 1402 may perform a retransmission of the TB via a first retransmission occasion based on receiving a NACK in response to transmitting the TB, the first retransmission occasion being configured for a subset of UEs that received the NACK. The Rx UE 1403 may receive a retransmission of the TB from the first UE via a first retransmission occasion based on receiving a NACK in response to transmitting the TB, the first retransmission occasion being configured for a subset of UEs that received the NACK.

Here, a subset of Tx UEs may be configured to use the retransmission occasion. The subset of UEs configured to perform the retransmission may be limited to UEs that received NACK in response to transmitting the SL TB in the first transmission occasion. This subset may be limited to one UE. By limiting or reducing the number of UEs performing retransmission during the retransmission occasions to a subset of UEs rather than the total set of UEs, the risk of collision for the retransmission may be reduced.

At 1420, the Rx UE 1403 may transmit an indication of a timer associated with the PSFCH, where the PSFCH is received in a subsequent available PSFCH resource after an expiration of the timer. The Tx UE 1402 may obtain an indication of a timer associated with the PSFCH, where the PSFCH is received in a subsequent available PSFCH resource after an expiration of the timer. Here, the indication of the timer may be obtained based on a function or a table for a number of the set of UEs.

At 1422, the Rx UE 1403 may transmit a maximum number of set of UEs in the set of UEs, where the indication of the timer is obtained based on the maximum number of set of UEs in the set of UEs. The Tx UE 1402 may receive a maximum number of set of UEs in the set of UEs, where the indication of the timer is obtained based on the maximum number of set of UEs in the set of UEs. The maximum number of set of UEs in the set of UEs may be configured per RP.

At 1424, the Rx UE 1403 may receive a PSFCH based on at least one of the transmission or the retransmission of the TB, where the PSFCH may be received based on grant-free NOMA for the sidelink communication, and the PSFCH may be received in a PRB carrying a second PSFCH. The Tx UE 1402 may transmit a PSFCH based on at least one of the transmission or the retransmission of the TB, where the PSFCH may be transmitted based on grant-free NOMA for the sidelink communication, and the PSFCH may be received in a PRB carrying a second PSFCH.

In one aspect, the PSFCH received by the Tx UE 1402 may be separated from the second PSFCH in at least one of a power domain or a coding domain. The PSFCH may be separated from the second PSFCH based on at least one of a source ID, a destination ID, a zone ID, a data priority, a QoS, a NOMA ID for determining the PRB, one or more DMRS parameters for a PSCCH or a PSSCH, a RV index, a number of CBGs or CBs, or a CRC of the PSCCH or the PSSCH.

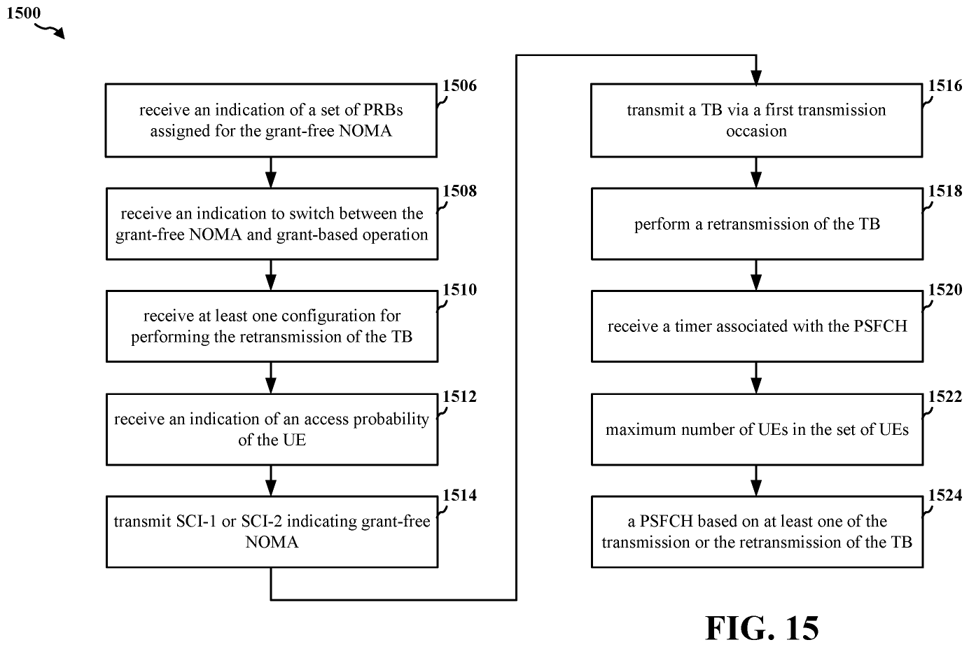

FIG. 15 is a flowchart 1500 of a method of wireless communication. The method may be performed by a UE (e.g., the UE 104, the apparatus 1904). Here, the UE may be a Tx UE. The network node may be at least one of a gNB, a PLC, or a primary UE. The Tx UE may be configured with a set of PRBs assigned for the grant-free NOMA, and the Tx UE may transmit a TB via a first transmission occasion and perform a retransmission of the TB in at least one retransmission occasion. In response to the transmission of the TB, the Rx UE may transmit the PSFCH on the grant-free NOMA.

At 1506, the UE may receive an indication of a set of PRBs assigned for the grant-free NOMA, where at least one PRB of the set of PRB is associated with more than one slot of a PSSCH. For example, the network node may configure the first set of resources, the second set of resources, and the third set of resources for the set of UEs including the UE and the Rx UE to perform NOMA sidelink communication. The UE may reserve the first set of resources for the initial transmission of a TB, and reserve the second set of resources and/or the third set of resources for the retransmission of the TB. For example, at 1406, the UE 1402 may receive an indication of a set of PRBs assigned for the grant-free NOMA, where at least one PRB of the set of PRB is associated with more than one slot of a PSSCH. Furthermore, 1506 may be performed by a NOMA SL component 198.

At 1508, the UE may receive an indication of a set of PRB s assigned for the grant-free NOMA, where at least one PRB of the set of PRB is associated with more than one slot of a PSSCH. For example, at 1408, the Tx UE 1402 may receive an indication of a set of PRB s assigned for the grant-free NOMA, where at least one PRB of the set of PRB is associated with more than one slot of a PSSCH. Furthermore, 1508 may be performed by the NOMA SL component 198.

At 1510, the UE may obtain at least one configuration for performing the retransmission of the TB. The retransmission pattern regarding which UEs to be selected for each transmission or retransmission occasions may be indicated by the RRC message or the MAC-CE, or transmitted in the L1 indication before the first transmission occasion and be agreed between the set of UEs performing the NOMA and the Rx SL UE. For example, at 1410, the Tx UE 1402 may obtain at least one configuration for performing the retransmission of the TB. Furthermore, 1510 may be performed by the NOMA SL component 198.

In some aspects, the at least one configuration may include a power configuration associated with the retransmission of the TB, where the power configuration is based on the subset of Tx UEs. In another aspect, the at least one configuration may include a DMRS configuration associated with the retransmission of the TB, where the DMRS configuration is based on the subset of Tx UEs.

In one aspect, the power control parameters/configurations during each retransmission may be same or different, in part based on a change of the subset of UEs participating the NOMA operation. That is, a power configuration associated with the retransmission of the TB may be based on the subset of UEs configured to perform the retransmission. The second subset of UEs may be configured to perform the second retransmission. Accordingly, the first power control parameter/configurations and the second power control parameter/configurations may be different for the first retransmission and the second retransmission.

At 1512, the UE may receive an indication of an access probability of the UE from a network node, where the UE is selected in the set of Tx set of UEs to perform the transmission of the TB and the subset of Tx set of UEs to perform the retransmission of the TB based on the access probability of the UE. For example, at 1412, the Tx UE 1402 may receive an indication of an access probability of the Tx UE 1402 from a network node 1404, where the Tx UE 1402 is selected in the set of Tx set of UEs to perform the transmission of the TB and the subset of Tx set of UEs to perform the retransmission of the TB based on the access probability of the Tx UE. Furthermore, 1512 may be performed by the NOMA SL component 198.

At 1514, the UE may transmit SCI-1 or SCI-2 indicating that the transmission of the TB is associated with the grant-free NOMA. Based on the indication of the grant-free NOMA operation in the SCI-1 or the SCI-2, the Rx SL UE may identify the PRBs used for NOMA in case different sets of PRBs are used for reporting PSFCH on the NOMA operation and the non-NOMA operation. The Rx SL UE, the network node, or the PLC may send an indication in at least one of the L1 signal, the L2 signal, or the L3 signal before the grant-free NOMA transmission to indicate to other UEs whether the corresponding sidelink transmission is on the grant-free NOMA or not, and notify the associated processing time. For example, at 1414, the Tx UE 1402 may transmit SCI-1 or SCI-2 indicating that the transmission of the TB is associated with the grant-free NOMA. Furthermore, 1514 may be performed by the NOMA SL component 198.

At 1516, the UE may transmit a TB via a first transmission occasion configured for a set of UEs including the UE, the first transmission occasion being associated with grant-free NOMA for sidelink communication. Here, the first transmission of a grant (configured or dynamic) may be used by the set of Tx UEs to perform the grant-free NOMA operation. For example, at 1416, the UE 1412 may transmit a TB via a first transmission occasion configured for a set of UEs including the UE. Furthermore, 1516 may be performed by a NOMA SL component 198.

At 1518, the UE may receive a retransmission of the TB from the first UE via a first retransmission occasion based on receiving a NACK in response to transmitting the TB, the first retransmission occasion being configured for a subset of UEs that received the NACK. Here, a subset of Tx UEs may be configured to use the retransmission occasion. The subset of UEs configured to perform the retransmission may be limited to UEs that received NACK in response to transmitting the SL TB in the first transmission occasion. This subset may be limited to one UE. By limiting or reducing the number of UEs performing retransmission during the retransmission occasions to a subset of UEs rather than the total set of UEs, the risk of collision for the retransmission may be reduced. For example, at 1418, the UE 1412 may receive a retransmission of the TB from the first UE via a first retransmission occasion based on receiving a NACK in response to transmitting the TB, the first retransmission occasion being configured for a subset of UEs that received the NACK. Furthermore, 1518 may be performed by the NOMA SL component 198.

At 1520, the UE may obtain an indication of a timer associated with the PSFCH, where the PSFCH is received in a subsequent available PSFCH resource after an expiration of the timer. Here, the indication of the timer may be obtained based on a function or a table for a number of set of UEs. For example, at 1410, the Tx UE 1402 may obtain an indication of a timer associated with the PSFCH, where the PSFCH is received in a subsequent available PSFCH resource after an expiration of the timer. Furthermore, 1520 may be performed by the NOMA SL component 198.

At 1522, the UE may receive a maximum number of set of UEs in the set of UEs, where the indication of the timer is obtained based on the maximum number of set of UEs in the set of UEs. The maximum number of set of UEs in the set of UEs may be configured per RP. For example, at 1412, the Tx UE 1402 may receive a maximum number of set of UEs in the set of UEs, where the indication of the timer is obtained based on the maximum number of set of UEs in the set of UEs. Furthermore, 1522 may be performed by the NOMA SL component 198.

At 1524, the UE may transmit a PSFCH based on at least one of the transmission or the retransmission of the TB, where the PSFCH may be transmitted based on grant-free NOMA for the sidelink communication, and the PSFCH may be received in a PRB carrying a second PSFCH. In one aspect, the PSFCH received by the UE may be separated from the second PSFCH in at least one of a power domain or a coding domain. The PSFCH may be separated from the second PSFCH based on at least one of a source ID, a destination ID, a zone ID, a data priority, a QoS, a NOMA ID for determining the PRB, one or more DMRS parameters for a PSCCH or a PSSCH, a RV index, a number of CBGs or CBs, or a CRC of the PSCCH or the PSSCH. For example, at 1414, the Tx UE 1402 may transmit a PSFCH based on at least one of the transmission or the retransmission of the TB, where the PSFCH may be transmitted based on grant-free NOMA for the sidelink communication, and the PSFCH may be received in a PRB carrying a second PSFCH. Furthermore, 1524 may be performed by the NOMA SL component 198.

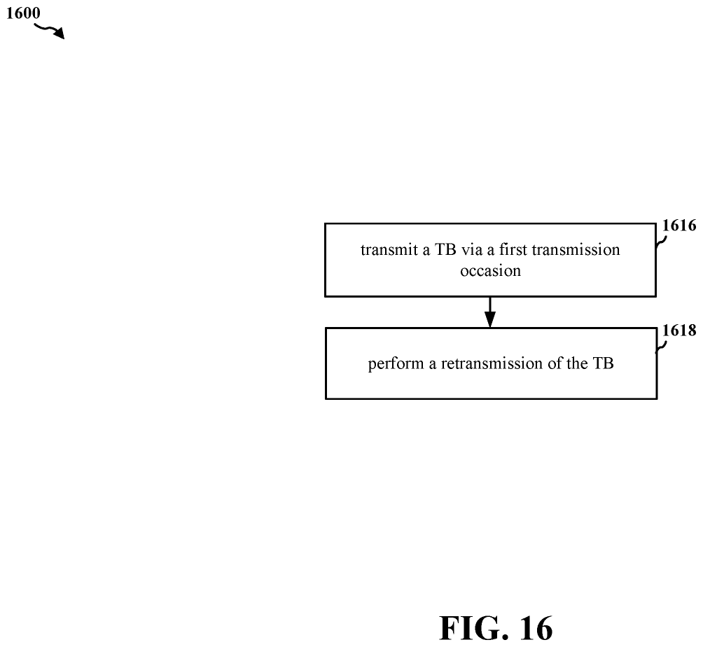

FIG. 16 is a flowchart 1600 of a method of wireless communication. The method may be performed by a UE (e.g., the UE 104, the apparatus 1904). Here, the UE may be a Tx UE. The network node may be at least one of a gNB, a PLC, or a primary UE. The UE may be configured with a set of PRBs assigned for the grant-free NOMA, and the UE may transmit a TB via a first transmission occasion and perform a retransmission of the TB in at least one retransmission occasion. In response to the transmission of the TB, the Rx UE may transmit the PSFCH on the grant-free NOMA.

At 1616, the UE may transmit a TB via a first transmission occasion configured for a set of UEs including the UE, the first transmission occasion being associated with grant-free NOMA for sidelink communication. Here, the first transmission of a grant (configured or dynamic) may be used by the set of Tx UEs to perform the grant-free NOMA operation. For example, at 1416, the UE 1412 may transmit a TB via a first transmission occasion configured for a set of UEs including the UE. Furthermore, 1616 may be performed by a NOMA SL component 198.

At 1618, the UE may receive a retransmission of the TB from the first UE via a first retransmission occasion based on receiving a NACK in response to transmitting the TB, the first retransmission occasion being configured for a subset of UEs that received the NACK. Here, a subset of Tx UEs may be configured to use the retransmission occasion. The subset of UEs configured to perform the retransmission may be limited to UEs that received NACK in response to transmitting the SL TB in the first transmission occasion. This subset may be limited to one UE. By limiting or reducing the number of UEs performing retransmission during the retransmission occasions to a subset of UEs rather than the total set of UEs, the risk of collision for the retransmission may be reduced. For example, at 1418, the UE 1412 may receive a retransmission of the TB from the first UE via a first retransmission occasion based on receiving a NACK in response to transmitting the TB, the first retransmission occasion being configured for a subset of UEs that received the NACK. Furthermore, 1618 may be performed by the NOMA SL component 198.

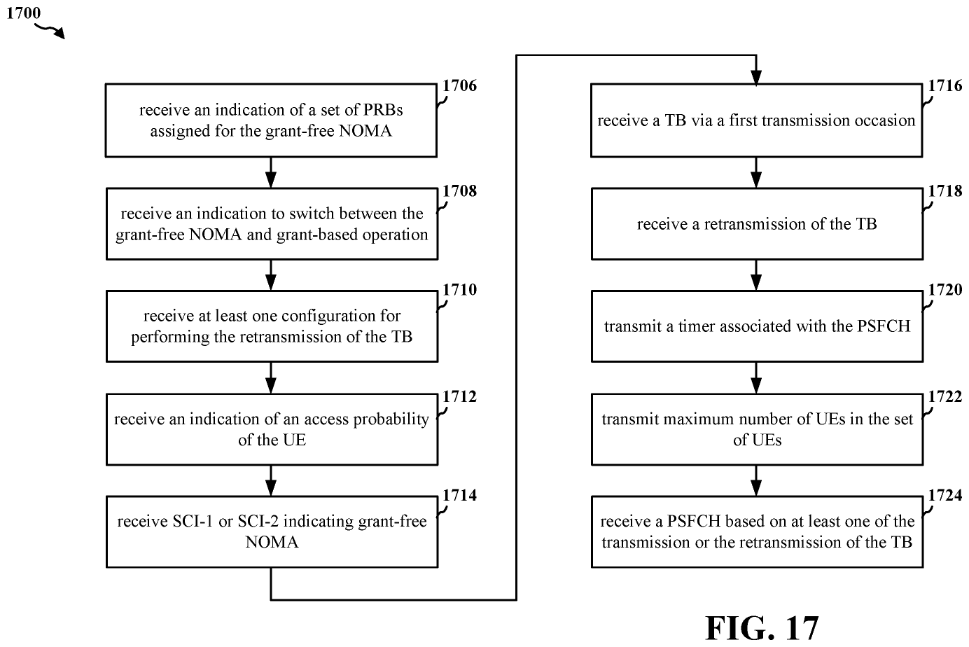

FIG. 17 is a flowchart 1700 of a method of wireless communication. The method may be performed by a UE (e.g., the UE 104, the apparatus 1904). Here, the UE may be a Rx UE. The network node may be at least one of a gNB, a PLC, or a primary UE. The Tx UE may be configured with a set of PRBs assigned for the grant-free NOMA, and the Tx UE may transmit a TB via a first transmission occasion and perform a retransmission of the TB in at least one retransmission occasion. In response to the transmission of the TB, the UE may transmit the PSFCH on the grant-free NOMA.

At 1706, the UE may receive an indication of a set of PRBs assigned for the grant-free NOMA, where at least one PRB of the set of PRB is associated with more than one slot of a PSSCH. For example, the network node may configure the first set of resources, the second set of resources, and the third set of resources for the set of UEs including the Tx UE and the UE to perform NOMA sidelink communication. The Tx UE may reserve the first set of resources for the initial transmission of a TB, and reserve the second set of resources and/or the third set of resources for the retransmission of the TB. For example, at 1406, the Rx UE 1403 may receive an indication of a set of PRBs assigned for the grant-free NOMA, where at least one PRB of the set of PRB is associated with more than one slot of a PSSCH. Furthermore, 1706 may be performed by a NOMA SL component 198.

At 1708, the UE may receive an indication to switch between the grant-free NOMA and grant-based NOMA for the sidelink communication. For example, at 1408, the Rx UE 1403 may receive an indication to switch between the grant-free NOMA and grant-based NOMA for the sidelink communication. Furthermore, 1708 may be performed by the NOMA SL component 198.

At 1710, the UE may obtain at least one configuration for performing the retransmission of the TB. The retransmission pattern regarding which UEs to be selected for each transmission or retransmission occasions may be indicated by the RRC message or the MAC-CE, or transmitted in the L1 indication before the first transmission occasion and be agreed between the set of UEs performing the NOMA and the Rx SL UE. For example, at 1410, the Rx UE 1403 may obtain at least one configuration for performing the retransmission of the TB. Furthermore, 1710 may be performed by the NOMA SL component 198.

In some aspects, the at least one configuration may include a power configuration associated with the retransmission of the TB, where the power configuration is based on the subset of Tx UEs. In another aspect, the at least one configuration may include a DMRS configuration associated with the retransmission of the TB, where the DMRS configuration is based on the subset of Tx UEs.

In one aspect, the power control parameters/configurations during each retransmission may be same or different, in part based on a change of the subset of UEs participating the NOMA operation. That is, a power configuration associated with the retransmission of the TB may be based on the subset of UEs configured to perform the retransmission. The second subset of UEs may be configured to perform the second retransmission. Accordingly, the first power control parameter/configurations and the second power control parameter/configurations may be different for the first retransmission and the second retransmission.

At 1712, the UE may receive an indication of an access probability of the Tx UE from the network node, where the Tx UE is selected in the set of UEs to perform the transmission of the TB and the subset of UEs to perform the retransmission of the TB based on the access probability of the Tx UE. For example, at 1412, the Rx UE 1403 may receive an indication of an access probability of the Tx UE 1402 from the network node 1404, where the Tx UE 1402 is selected in the set of UEs to perform the transmission of the TB and the subset of UEs to perform the retransmission of the TB based on the access probability of the Tx UE. Furthermore, 1712 may be performed by the NOMA SL component 198.

At 1714, the UE may receive SCI-1 or SCI-2 indicating that the transmission of the TB is associated with the grant-free NOMA. Based on the indication of the grant-free NOMA operation in the SCI-1 or the SCI-2, the Rx SL UE may identify the PRBs used for NOMA in case different sets of PRBs are used for reporting PSFCH on the NOMA operation and the non-NOMA operation. The Rx SL UE, the network node, or the PLC may send an indication in at least one of the L1 signal, the L2 signal, or the L3 signal before the grant-free NOMA transmission to indicate to other UEs whether the corresponding sidelink transmission is on the grant-free NOMA or not, and notify the associated processing time. For example, at 1414, the Rx UE 1403 may receive SCI-1 or SCI-2 indicating that the transmission of the TB is associated with the grant-free NOMA. Furthermore, 1714 may be performed by the NOMA SL component 198.

At 1716, the UE may receive a TB from a first UE via a first transmission occasion configured for a set of UEs including the first UE, the first transmission occasion being associated with grant-free NOMA for sidelink communication. For example, at 1416, the UE 1412 may receive a TB from a first UE via a first transmission occasion configured for a set of UEs including the first UE, the first transmission occasion being associated with grant-free NOMA for sidelink communication. Furthermore, 1716 may be performed by a NOMA SL component 198.

At 1718, the UE may perform a retransmission of the TB via a first retransmission occasion based on receiving a NACK in response to transmitting the TB, the first retransmission occasion being configured for a subset of UEs that received the NACK. Here, a subset of Tx UEs may be configured to use the retransmission occasion. The subset of UEs configured to perform the retransmission may be limited to UEs that received NACK in response to transmitting the SL TB in the first transmission occasion. This subset may be limited to one UE. By limiting or reducing the number of UEs performing retransmission during the retransmission occasions to a subset of UEs rather than the total set of UEs, the risk of collision for the retransmission may be reduced. For example, at 1418, the UE 1412 may perform a retransmission of the TB via a first retransmission occasion based on receiving a NACK in response to transmitting the TB, the first retransmission occasion being configured for a subset of UEs that received the NACK. Furthermore, 1718 may be performed by the NOMA SL component 198.

At 1720, the UE may transmit an indication of a timer associated with the PSFCH, where the PSFCH is received in a subsequent available PSFCH resource after an expiration of the timer. Here, the indication of the timer may be obtained based on a function or a table for a number of set of UEs. For example, at 1410, the Rx UE 1403 may transmit an indication of a timer associated with the PSFCH, where the PSFCH is received in a subsequent available PSFCH resource after an expiration of the timer. Furthermore, 1720 may be performed by the NOMA SL component 198.

At 1722, the UE may transmit a maximum number of set of UEs in the set of UEs, where the indication of the timer is obtained based on the maximum number of set of UEs in the set of UEs. The maximum number of set of UEs in the set of UEs may be configured per RP. For example, at 1412, the Rx UE 1403 may transmit a maximum number of set of UEs in the set of UEs, where the indication of the timer is obtained based on the maximum number of set of UEs in the set of UEs. Furthermore, 1722 may be performed by the NOMA SL component 198.

At 1724, the UE may receive a PSFCH based on at least one of the transmission or the retransmission of the TB, where the PSFCH may be received based on grant-free NOMA for the sidelink communication, and the PSFCH may be received in a PRB carrying a second PSFCH. In one aspect, the PSFCH received by the Tx UE may be separated from the second PSFCH in at least one of a power domain or a coding domain. The PSFCH may be separated from the second PSFCH based on at least one of a source ID, a destination ID, a zone ID, a data priority, a QoS, a NOMA ID for determining the PRB, one or more DMRS parameters for a PSCCH or a PSSCH, a RV index, a number of CBGs or CBs, or a CRC of the PSCCH or the PSSCH. For example, at 1414, the Tx UE 1402 may receive a PSFCH based on at least one of the transmission or the retransmission of the TB, where the PSFCH may be received based on grant-free NOMA for the sidelink communication, and the PSFCH may be received in a PRB carrying a second PSFCH. Furthermore, 1724 may be performed by the NOMA SL component 198.

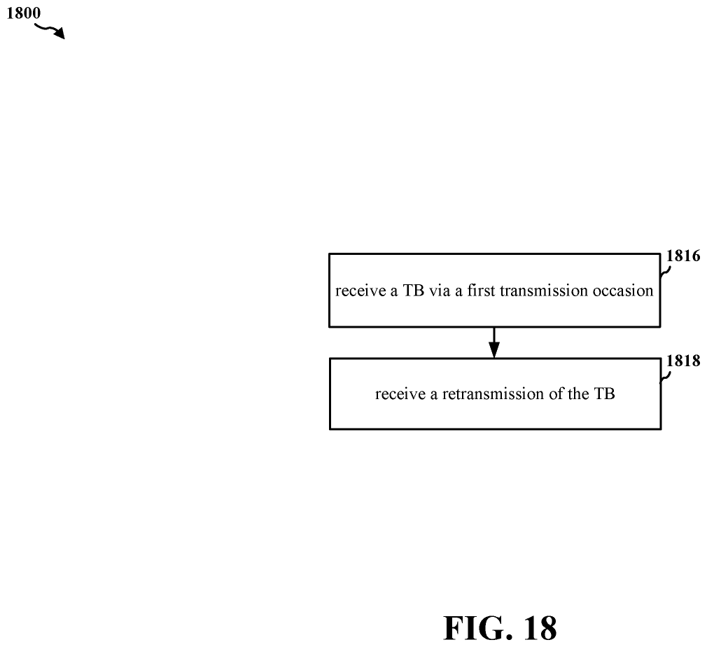

FIG. 18 is a flowchart 1800 of a method of wireless communication. The method may be performed by a UE (e.g., the UE 104, the apparatus 1904). Here, the UE may be a Rx UE. The network node may be at least one of a gNB, a PLC, or a primary UE. The Tx UE may be configured with a set of PRBs assigned for the grant-free NOMA, and the Tx UE may transmit a TB via a first transmission occasion and perform a retransmission of the TB in at least one retransmission occasion. In response to the transmission of the TB, the UE may transmit the PSFCH on the grant-free NOMA.

At 1816, the UE may receive a TB from a first UE via a first transmission occasion configured for a set of UEs including the first UE, the first transmission occasion being associated with grant-free NOMA for sidelink communication. For example, at 1416, the UE 1412 may receive a TB from a first UE via a first transmission occasion configured for a set of UEs including the first UE, the first transmission occasion being associated with grant-free NOMA for sidelink communication. Furthermore, 1816 may be performed by a NOMA SL component 198.

At 1818, the UE may perform a retransmission of the TB via a first retransmission occasion based on receiving a NACK in response to transmitting the TB, the first retransmission occasion being configured for a subset of UEs that received the NACK. Here, a subset of Tx UEs may be configured to use the retransmission occasion. The subset of UEs configured to perform the retransmission may be limited to UEs that received NACK in response to transmitting the SL TB in the first transmission occasion. This subset may be limited to one UE. By limiting or reducing the number of UEs performing retransmission during the retransmission occasions to a subset of UEs rather than the total set of UEs, the risk of collision for the retransmission may be reduced. For example, at 1418, the UE 1412 may perform a retransmission of the TB via a first retransmission occasion based on receiving a NACK in response to transmitting the TB, the first retransmission occasion being configured for a subset of UEs that received the NACK. Furthermore, 1818 may be performed by the NOMA SL component 198.

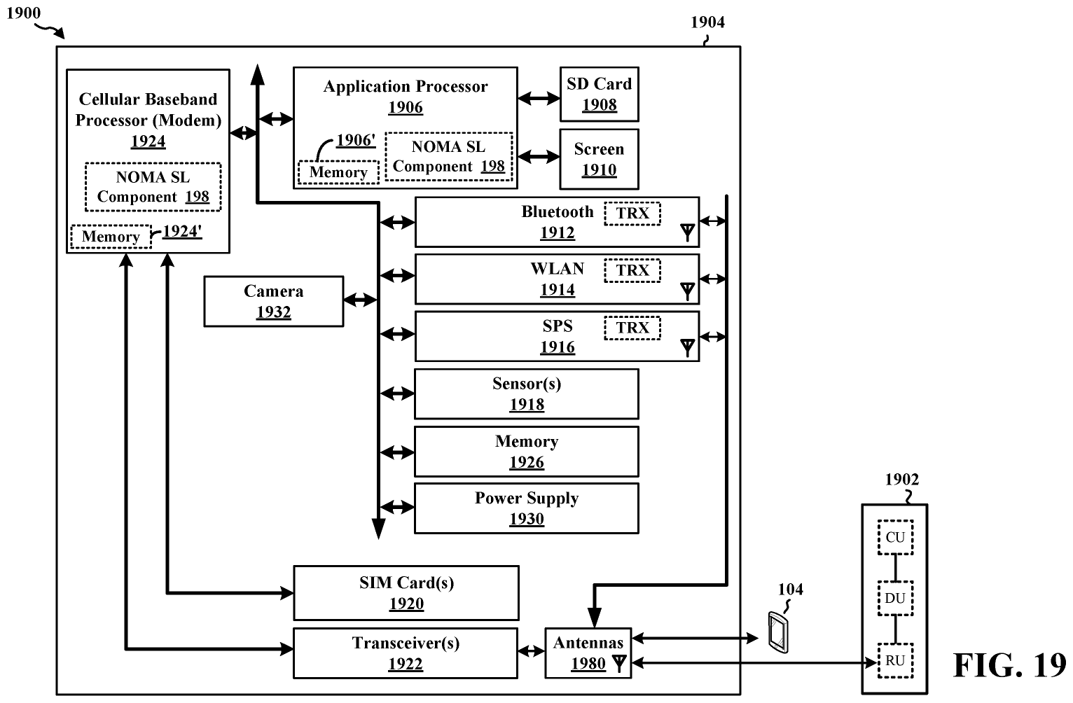

FIG. 19 is a diagram 1900 illustrating an example of a hardware implementation for an apparatus 1904. The apparatus 1904 may be a UE, a component of a UE, or may implement UE functionality. In some aspects, the apparatus 1904 may include a cellular baseband processor 1924 (also referred to as a modem) coupled to one or more transceivers 1922 (e.g., cellular RF transceiver). The cellular baseband processor 1924 may include on-chip memory 1924′. In some aspects, the apparatus 1904 may further include one or more subscriber identity modules (SIM) cards 1920 and an application processor 1906 coupled to a secure digital (SD) card 1908 and a screen 1910. The application processor 1906 may include on-chip memory 1906′. In some aspects, the apparatus 1904 may further include a Bluetooth module 1912, a WLAN module 1914, an SPS module 1916 (e.g., GNSS module), one or more sensor modules 1918 (e.g., barometric pressure sensor/altimeter, motion sensor such as inertial measurement unit (IMU), gyroscope, and/or accelerometer(s), light detection and ranging (LIDAR), radio assisted detection and ranging (RADAR), sound navigation and ranging (SONAR), magnetometer, audio and/or other technologies used for positioning), additional memory modules 1926, a power supply 1930, and/or a camera 1932. The Bluetooth module 1912, the WLAN module 1914, and the SPS module 1916 may include an on-chip transceiver (TRX) (or in some cases, just a receiver (RX)). The Bluetooth module 1912, the WLAN module 1914, and the SPS module 1916 may include their own dedicated antennas and/or utilize the antennas 1980 for communication. The cellular baseband processor 1924 communicates through the transceiver(s) 1922 via one or more antennas 1980 with the UE 104 and/or with an RU associated with a network entity 1902. The cellular baseband processor 1924 and the application processor 1906 may each include a computer-readable medium/memory 1924′, 1906′, respectively. The additional memory modules 1926 may also be considered a computer-readable medium/memory. Each computer-readable medium/memory 1924′, 1906′, 1926 may be non-transitory. The cellular baseband processor 1924 and the application processor 1906 are each responsible for general processing, including the execution of software stored on the computer-readable medium/memory. The software, when executed by the cellular baseband processor 1924/application processor 1906, causes the cellular baseband processor 1924/application processor 1906 to perform the various functions described supra. The computer-readable medium/memory may also be used for storing data that is manipulated by the cellular baseband processor 1924/application processor 1906 when executing software. The cellular baseband processor 1924/application processor 1906 may be a component of the UE 350 and may include the memory 360 and/or at least one of the TX processor 368, the RX processor 356, and the controller/processor 359. In one configuration, the apparatus 1904 may be a processor chip (modem and/or application) and include just the cellular baseband processor 1924 and/or the application processor 1906, and in another configuration, the apparatus 1904 may be the entire UE (e.g., see 350 of FIG. 3) and include the additional modules of the apparatus 1904.

As discussed supra, the NOMA SL component 198 is configured to obtain at least one configuration of a set of RPs from a network node, the set of RPs being associated with grant-free NOMA for sidelink communication, and transmit a sidelink transmission via a sidelink channel to at least one other UE in the set of RPs associated with the grant-free NOMA based on the at least one configuration of the set of RPs. The NOMA SL component 198 may be within the cellular baseband processor 1924, the application processor 1906, or both the cellular baseband processor 1924 and the application processor 1906. The NOMA SL component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1904 may include a variety of components configured for various functions.

In one aspect, the apparatus 1904 may be a Tx UE (e.g., the Tx UE 902). In one configuration, the apparatus 1904, and in particular the cellular baseband processor 1924 and/or the application processor 1906, includes means for obtaining at least one configuration of a set of RPs from a network node, the set of RPs being associated with grant-free NOMA for sidelink communication, and means for transmitting a sidelink transmission via a sidelink channel to at least one other UE in the set of RPs associated with the grant-free NOMA based on the at least one configuration of the set of RPs. In one configuration, the at least one configuration of the set of RPs includes a set of FD-OCCs and DMRS configuration IDs associated with at least one of a PSCCH or a PSSCH, and the sidelink channel includes at least one of the PSCCH or the PSSCH. In one configuration, the at least one configuration of the set of RPs indicates at least one sub-RP assigned for the grant-free NOMA for the sidelink communication. In one configuration, the at least one configuration of the set of RPs includes dedicated configured grants shared by a plurality of UEs including the UE to perform grant-free sidelink communication. In one configuration, the apparatus 1904, and in particular the cellular baseband processor 1924 and/or the application processor 1906, further includes means for receiving an instruction to activate or deactivate the NOMA for the sidelink communication based on at least one of a cast type, a data priority, or a QoS. In one configuration, the instruction to activate or deactivate the NOMA is received via at least one of a L1 signal, a L2 signal, or a L3 signal. In one configuration, the instruction to activate or deactivate the NOMA includes an indication of a timer, and the grant-free NOMA is activated or deactivated until an expiration of the timer. In one configuration, the apparatus 1904, and in particular the cellular baseband processor 1924 and/or the application processor 1906, further includes means for selecting a power configuration associated with one or more of at least one PSCCH or at least one PSSCH on the set of RPs, where the power configuration is selected from a set of applicable power configurations. In one configuration, the power configuration is selected based on at least one of a source ID, a destination ID, a zone ID, a data priority, a QoS, a PSCCH CRC, one or more configured IDs for randomization, or a cast type. In one configuration, the apparatus 1904, and in particular the cellular baseband processor 1924 and/or the application processor 1906, further includes means for selecting a DMRS configuration associated with one or more or at least one PSCCH or at least one PSSCH on the set of RPs, where the DMRS configuration is selected from a set of applicable DMRS configurations. In one configuration, the DMRS configuration is selected based on at least one of a source ID, a destination ID, a zone ID, a data priority, a QoS, a CRC of SCI-1, one or more configured IDs for randomization, or a cast type. In one configuration, the DMRS configuration includes a DMRS scrambling ID determined based on at least one of a source ID, a destination ID, a zone ID, a data priority, a QoS, a CRC of SCI-1, one or more configured IDs for randomization, or a cast type. In one configuration, the apparatus 1904, and in particular the cellular baseband processor 1924 and/or the application processor 1906, further includes means for receiving a power configuration or a DMRS configuration associated with at least one PSCCH or at least one PSSCH on the set of RPs. In one configuration, the at least one configuration of the set of RPs includes a set of FD-OCCs associated with a PSCCH, and an oversampling factor is applied to the set of FD-OCC.

In one aspect, the apparatus 1904 may be a Tx UE (e.g., the Tx UE 1402). In one configuration, the apparatus 1904, and in particular the cellular baseband processor 1924 and/or the application processor 1906, includes means for transmitting a TB via a first transmission occasion configured for a set of UEs including the UE, the first transmission occasion being associated with grant-free NOMA for sidelink communication, and means for performing a retransmission of the TB via a first retransmission occasion based on receiving a NACK in response to transmitting the TB, the first retransmission occasion being configured for a subset of UEs that received the NACK. In one configuration, the apparatus 1904, and in particular the cellular baseband processor 1924 and/or the application processor 1906, further includes means for obtaining at least one configuration for performing the retransmission of the TB. In one configuration, the at least one configuration includes a power configuration associated with the retransmission of the TB, where the power configuration is based on the subset of UEs. In one configuration, the at least one configuration includes a DMRS configuration associated with the retransmission of the TB, where the DMRS configuration is based on the subset of UEs. In one configuration, the apparatus 1904, and in particular the cellular baseband processor 1924 and/or the application processor 1906, further includes means for receiving an indication of an access probability of the UE from a network node, where the UE is selected in the set of UEs to perform the transmission of the TB and the subset of UEs to perform the retransmission of the TB based on the access probability of the UE. In one configuration, the apparatus 1904, and in particular the cellular baseband processor 1924 and/or the application processor 1906, further includes means for receiving an indication to switch between the grant-free NOMA and grant-based NOMA for the sidelink communication. In one configuration, the apparatus 1904, and in particular the cellular baseband processor 1924 and/or the application processor 1906, further includes means for receiving a PSFCH based on at least one of the transmission or the retransmission of the TB, where the PSFCH is received based on grant-free NOMA for the sidelink communication, and the PSFCH is received in a PRB carrying a second PSFCH. In one configuration, the PSFCH received by the UE is separated from the second PSFCH in at least one of a power domain or a coding domain. In one configuration, the apparatus 1904, and in particular the cellular baseband processor 1924 and/or the application processor 1906, further includes means for receiving an indication of a set of PRBs assigned for the grant-free NOMA, where at least one PRB of the set of PRB is associated with more than one slot of a PSSCH. In one configuration, the PSFCH is separated from the second PSFCH based on at least one of a source ID, a destination ID, a zone ID, a data priority, a QoS, a NOMA ID for determining the PRB, one or more DMRS parameters for a PSCCH or a PSSCH, a RV index, a number of CBGs or CBs, or a CRC of the PSCCH or the PSSCH. In one configuration, the apparatus 1904, and in particular the cellular baseband processor 1924 and/or the application processor 1906, further includes means for obtaining an indication of a timer associated with the PSFCH, where the PSFCH is received in a subsequent available PSFCH resource after an expiration of the timer. In one configuration, the indication of the timer is obtained based on a function or a table for a number of UEs of the set of UEs. In one configuration, the apparatus 1904, and in particular the cellular baseband processor 1924 and/or the application processor 1906, further includes means for receiving a maximum number of UEs in the set of UEs, where the indication of the timer is obtained based on the maximum number of UEs in the set of UEs. In one configuration, the maximum number of UEs in the set of UEs is configured per RP. In one configuration, the apparatus 1904, and in particular the cellular baseband processor 1924 and/or the application processor 1906, further includes means for transmitting SCI-1 or SCI-2 indicating that the transmission of the TB is associated with the grant-free NOMA.

In one aspect, the apparatus 1904 may be a Rx UE (e.g., the Rx UE 1403). In one configuration, the apparatus 1904, and in particular the cellular baseband processor 1924 and/or the application processor 1906, includes means for means for receiving a TB from a first UE via a first transmission occasion configured for a set of UEs including the first UE, the first transmission occasion being associated with grant-free NOMA for sidelink communication, and means for receiving a retransmission of the TB from the first UE via a first retransmission occasion based on receiving a NACK in response to transmitting the TB, the first retransmission occasion being configured for a subset of UEs that received the NACK. In one configuration, the apparatus 1904, and in particular the cellular baseband processor 1924 and/or the application processor 1906, further includes means for obtaining at least one configuration for performing the retransmission of the TB. In one configuration, the at least one configuration includes a power configuration associated with the retransmission of the TB, where the power configuration is based on the subset of UEs. In one configuration, the at least one configuration includes a DMRS configuration associated with the retransmission of the TB, where the DMRS configuration is based on the subset of UEs. In one configuration, the apparatus 1904, and in particular the cellular baseband processor 1924 and/or the application processor 1906, further includes means for receiving an indication of an access probability of the first UE from a network node, where the first UE is selected in the set of UEs to perform the transmission of the TB and the subset of UEs to perform the retransmission of the TB based on the access probability of the UE. In one configuration, the apparatus 1904, and in particular the cellular baseband processor 1924 and/or the application processor 1906, further includes means for receiving an indication to switch between the grant-free NOMA and grant-based NOMA for the sidelink communication. In one configuration, the apparatus 1904, and in particular the cellular baseband processor 1924 and/or the application processor 1906, further includes means for transmitting a PSFCH to the first UE based on at least one of the transmission or the retransmission of the TB, where the PSFCH is transmitted based on grant-free NOMA for the sidelink communication, and the PSFCH is received in a PRB carrying a second PSFCH. In one configuration, the PSFCH transmitted to the first UE is separated from the second PSFCH in at least one of a power domain or a coding domain. In one configuration, the apparatus 1904, and in particular the cellular baseband processor 1924 and/or the application processor 1906, further includes means for receiving an indication of a set of PRBs assigned for the grant-free NOMA, where at least one PRB of the set of PRB is associated with more than one slot of a PSSCH. In one configuration, the PSFCH is separated from the second PSFCH based on at least one of a source ID, a destination ID, a zone ID, a data priority, a QoS, a NOMA ID for determining the PRB, one or more DMRS parameters for a PSCCH or a PSSCH, a RV index, a number of CBGs or CBs, or a CRC of the PSCCH or the PSSCH. In one configuration, the apparatus 1904, and in particular the cellular baseband processor 1924 and/or the application processor 1906, further includes means for transmitting an indication of a timer associated with the PSFCH, where the PSFCH is received in a subsequent available PSFCH resource after an expiration of the timer. In one configuration, the indication of the timer is obtained based on a function or a table for a number of UEs of the set of UEs. In one configuration, the apparatus 1904, and in particular the cellular baseband processor 1924 and/or the application processor 1906, further includes means for transmitting a maximum number of UEs in the set of UEs, where the indication of the timer is obtained based on the maximum number of UEs in the set of UEs. In one configuration, the maximum number of UEs in the set of UEs is configured per RP. In one configuration, the apparatus 1904, and in particular the cellular baseband processor 1924 and/or the application processor 1906, further includes means for receiving SCI-1 or SCI-2 indicating that the transmission of the TB is associated with the grant-free NOMA.

The means may be the NOMA SL component 198 of the apparatus 1904 configured to perform the functions recited by the means. As described supra, the apparatus 1904 may include the TX processor 368, the RX processor 356, and the controller/processor 359. As such, in one configuration, the means may be the TX processor 368, the RX processor 356, and/or the controller/processor 359 configured to perform the functions recited by the means.

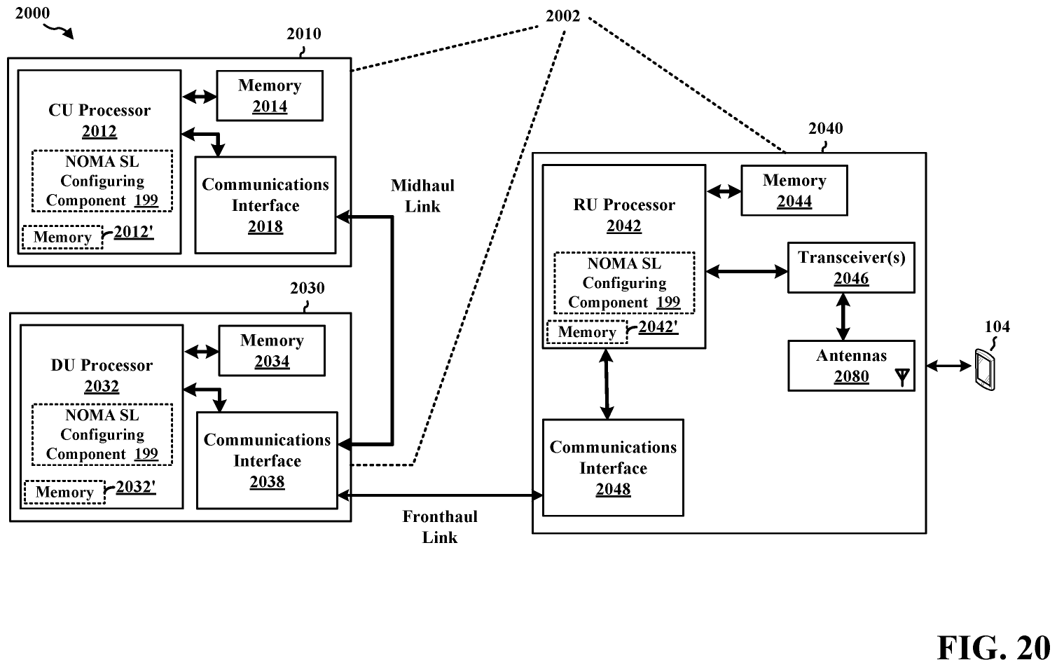

FIG. 20 is a diagram 2000 illustrating an example of a hardware implementation for a network entity 2002. The network entity 2002 may be a BS, a component of a BS, or may implement BS functionality. The network entity 2002 may include at least one of a CU 2010, a DU 2030, or an RU 2040. For example, depending on the layer functionality handled by the component 199, the network entity 2002 may include the CU 2010, both the CU 2010 and the DU 2030, each of the CU 2010, the DU 2030, and the RU 2040, the DU 2030, both the DU 2030 and the RU 2040, or the RU 2040. The CU 2010 may include a CU processor 2012. The CU processor 2012 may include on-chip memory 2012′. In some aspects, the CU 2010 may further include additional memory modules 2014 and a communications interface 2018. The CU 2010 communicates with the DU 2030 through a midhaul link, such as an F1 interface. The DU 2030 may include a DU processor 2032. The DU processor 2032 may include on-chip memory 2032′. In some aspects, the DU 2030 may further include additional memory modules 2034 and a communications interface 2038. The DU 2030 communicates with the RU 2040 through a fronthaul link. The RU 2040 may include an RU processor 2042. The RU processor 2042 may include on-chip memory 2042′. In some aspects, the RU 2040 may further include additional memory modules 2044, one or more transceivers 2046, antennas 2080, and a communications interface 2048. The RU 2040 communicates with the UE 104. The on-chip memory 2012′, 2032′, 2042′ and the additional memory modules 2014, 2034, 2044 may each be considered a computer-readable medium/memory. Each computer-readable medium/memory may be non-transitory. Each of the processors 2012, 2032, 2042 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 is configured to transmit at least one configuration of a set of RPs for a plurality of UEs including a first UE and a second UE, the set of RPs being associated with grant-free NOMA for sidelink communication between the plurality of UEs, and transmit an instruction to activate or deactivate the NOMA for the sidelink communication for the plurality of UEs, where a sidelink transmission is communicated between the first UE and the second UE via a sidelink channel in the set of RPs associated with the grant-free NOMA based on the at least one configuration of the sidelink channel. The component 199 may be within one or more processors of one or more of the CU 2010, DU 2030, and the RU 2040. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 2002 may include a variety of components configured for various functions. In one configuration, the network entity 2002 includes means for transmitting at least one configuration of a set of RPs for a plurality of UEs including a first UE and a second UE, the set of RPs being associated with grant-free NOMA for sidelink communication between the plurality of UEs, and means for transmitting an instruction to activate or deactivate the NOMA for the sidelink communication for the plurality of UEs, where a sidelink transmission is communicated between the first UE and the second UE via a sidelink channel in the set of RPs associated with the grant-free NOMA based on the at least one configuration of the sidelink channel. In one configuration, the at least one configuration of the set of RPs includes a set of FD-OCCs and DMRS configuration IDs associated with at least one of a PSCCH or a PSSCH, and the sidelink channel includes at least one of the PSCCH or the PSSCH. In one configuration, the at least one configuration of the set of RPs indicates at least one sub-RP assigned for the grant-free NOMA for the sidelink communication. In one configuration, the at least one configuration of the set of RPs includes dedicated configured grants shared by a plurality of UEs including the UE to perform grant-free sidelink communication. In one configuration, the instruction to activate or deactivate the NOMA for the sidelink communication is based on at least one of a cast type, a data priority, or a QoS. In one configuration, the instruction to activate or deactivate the NOMA is transmitted via at least one of a L1 signal, a L2 signal, or a L3 signal. In one configuration, the instruction to activate or deactivate the NOMA includes an indication of a timer, and the grant-free NOMA is activated or deactivated until an expiration of the timer. In one configuration, the network entity 2002 further includes means for transmitting a power configuration or a DMRS configuration associated with at least one PSCCH or at least one PSSCH on the set of RPs. In one configuration, the at least one configuration of the set of RPs includes a set of FD-OCCs associated with a PSCCH, and an oversampling factor is applied to the set of FD-OCC. The means may be the component 199 of the network entity 2002 configured to perform the functions recited by the means. As described supra, the network entity 2002 may include the TX processor 316, the RX processor 370, and the controller/processor 375. As such, in one configuration, the means may be the TX processor 316, the RX processor 370, and/or the controller/processor 375 configured to perform the functions recited by the means.

According some aspects of the current disclosure, the UE may be configured to obtain at least one configuration of a set of RPs from a network node, the set of RPs being associated with grant-free NOMA for sidelink communication, and transmit a sidelink transmission via a sidelink channel to at least one other UE in the set of RPs associated with the grant-free NOMA based on the at least one configuration of the set of RPs. The network node may be configured to transmit at least one configuration of a set of RPs for a plurality of UEs including a first UE and a second UE, the set of RPs being associated with grant-free NOMA for sidelink communication between the plurality of UEs, and transmit an instruction to activate or deactivate the NOMA for the sidelink communication for the plurality of UEs, where a sidelink transmission is communicated between the first UE and the second UE via a sidelink channel in the set of RPs associated with the grant-free NOMA based on the at least one configuration of the sidelink channel. Here, the at least one configuration of a set of RPs may include at least one of a power configuration, a DMRS configuration, or a set of FD-OCC associated with a PSCCH, and an oversampling factor is applied to the set of FD-OCC.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including obtaining at least one configuration of a set of RPs from a network node, the set of RPs being associated with grant-free NOMA for sidelink communication, and transmitting a sidelink transmission via a sidelink channel to at least one other UE in the set of RPs associated with the grant-free NOMA based on the at least one configuration of the set of RPs.

Aspect 2 is the method of aspect 1, where the at least one configuration of the set of RPs includes a set of FD-OCCs and DMRS configuration IDs associated with at least one of a PSCCH or a PSSCH, and the sidelink channel includes at least one of the PSCCH or the PSSCH.

Aspect 3 is the method of any of aspects 1 and 2, where the at least one configuration of the set of RPs indicates at least one sub-RP assigned for the grant-free NOMA for the sidelink communication.

Aspect 4 is the method of any of aspects 1 to 3, where the at least one configuration of the set of RPs includes dedicated configured grants shared by a plurality of UEs including the UE to perform grant-free sidelink communication.

Aspect 5 is the method of any of aspects 1 to 4, further including receiving an instruction to activate or deactivate the NOMA for the sidelink communication based on at least one of a cast type, a data priority, or a QoS.

Aspect 6 is the method of aspect 5, where the instruction to activate or deactivate the NOMA is received via at least one of a L1 signal, a L2 signal, or a L3 signal.

Aspect 7 is the method of any of aspects 5 and 6, where the instruction to activate or deactivate the NOMA includes an indication of a timer, and the grant-free NOMA is activated or deactivated until an expiration of the timer.

Aspect 8 is the method of any of aspects 1 to 7, further including selecting a power configuration associated with one or more of at least one PSCCH or at least one PSSCH on the set of RPs, where the power configuration is selected from a set of applicable power configurations.

Aspect 9 is the method of aspect 8, where the power configuration is selected based on at least one of a source ID, a destination ID, a zone ID, a data priority, a QoS, a PSCCH CRC, one or more configured IDs for randomization, or a cast type.

Aspect 10 is the method of any of aspects 1 to 9, further including selecting a DMRS configuration associated with one or more or at least one PSCCH or at least one PSSCH on the set of RPs, where the DMRS configuration is selected from a set of applicable DMRS configurations.

Aspect 11 is the method of aspect 10, where the DMRS configuration is selected based on at least one of a source ID, a destination ID, a zone ID, a data priority, a QoS, a CRC of SCI-1, one or more configured IDs for randomization, or a cast type.

Aspect 12 is the method of any of aspects 11 and 12, where the DMRS configuration includes a DMRS scrambling ID determined based on at least one of a source ID, a destination ID, a zone ID, a data priority, a QoS, a CRC of SCI-1, one or more configured IDs for randomization, or a cast type.

Aspect 13 is the method of any of aspects 1 to 12, further including receiving a power configuration or a DMRS configuration associated with at least one PSCCH or at least one PSSCH on the set of RPs.

Aspect 14 is the method of any of aspects 1 to 13, where the at least one configuration of the set of RPs includes a set of FD-OCCs associated with a PSCCH, and an oversampling factor is applied to the set of FD-OCC.

Aspect 15 is an apparatus for wireless communication including at least one processor coupled to a memory and configured to implement any of aspects 1 to 14, further including a transceiver coupled to the at least one processor.

Aspect 16 is an apparatus for wireless communication including means for implementing any of aspects 1 to 14.

Aspect 17 is a non-transitory computer-readable medium storing computer executable code, where the code when executed by a processor causes the processor to implement any of aspects 1 to 14.

Aspect 18 is a method of wireless communication at a network node, including transmitting at least one configuration of a set of RPs for a plurality of UEs including a first UE and a second UE, the set of RPs being associated with grant-free NOMA for sidelink communication between the plurality of UEs, and transmitting an instruction to activate or deactivate the NOMA for the sidelink communication for the plurality of UEs, where a sidelink transmission is communicated between the first UE and the second UE via a sidelink channel in the set of RPs associated with the grant-free NOMA based on the at least one configuration of the sidelink channel.

Aspect 19 is the method of aspect 18, where the at least one configuration of the set of RPs includes a set of FD-OCCs and DMRS configuration IDs associated with at least one of a PSCCH or a PSSCH, and the sidelink channel includes at least one of the PSCCH or the PSSCH.

Aspect 20 is the method of any of aspects 18 and 19, where the at least one configuration of the set of RPs indicates at least one sub-RP assigned for the grant-free NOMA for the sidelink communication.

Aspect 21 is the method of any of aspects 18 to 20, where the at least one configuration of the set of RPs includes dedicated configured grants shared by a plurality of UEs including the UE to perform grant-free sidelink communication.

Aspect 22 is the method of any of aspects 18 to 21, where the instruction to activate or deactivate the NOMA for the sidelink communication is based on at least one of a cast type, a data priority, or a QoS.

Aspect 23 is the method of aspect 22, where the instruction to activate or deactivate the NOMA is transmitted via at least one of a L1 signal, a L2 signal, or a L3 signal.

Aspect 24 is the method of any of aspects 22 and 23, where the instruction to activate or deactivate the NOMA includes an indication of a timer, and the grant-free NOMA is activated or deactivated until an expiration of the timer.

Aspect 25 is the method of any of aspects 18 to 24, further including transmitting a power configuration or a DMRS configuration associated with at least one PSCCH or at least one PSSCH on the set of RPs.

Aspect 26 is the method of any of aspects 18 to 25, where the at least one configuration of the set of RPs includes a set of FD-OCCs associated with a PSCCH, and an oversampling factor is applied to the set of FD-OCC.

Aspect 27 is an apparatus for wireless communication including at least one processor coupled to a memory and configured to implement any of aspects 18 to 26, further including a transceiver coupled to the at least one processor.

Aspect 28 is an apparatus for wireless communication including means for implementing any of aspects 18 to 26.

Aspect 29 is a non-transitory computer-readable medium storing computer executable code, where the code when executed by a processor causes the processor to implement any of aspects 18 to 26.

Aspect 30 is a method of wireless communication at a transmitting UE, including transmitting a TB via a first transmission occasion configured for a set of UEs including the UE, the first transmission occasion being associated with grant-free NOMA for sidelink communication, and performing a retransmission of the TB via a first retransmission occasion based on receiving a NACK in response to transmitting the TB, the first retransmission occasion being configured for a subset of UEs that received the NACK.

Aspect 31 is the method of aspect 30, further including obtaining at least one configuration for performing the retransmission of the TB.

Aspect 32 is the method of aspect 31, where the at least one configuration includes a power configuration associated with the retransmission of the TB, where the power configuration is based on the subset of UEs.

Aspect 33 is the method of any of aspects 31 to 32, where the at least one configuration includes a DMRS configuration associated with the retransmission of the TB, where the DMRS configuration is based on the subset of UEs.

Aspect 34 is the method of any of aspects 30 to 33, further including receiving an indication of an access probability of the UE from a network node, where the UE is selected in the set of UEs to perform the transmission of the TB and the subset of UEs to perform the retransmission of the TB based on the access probability of the UE.

Aspect 35 is the method of any of aspects 30 to 34, further including receiving an indication to switch between the grant-free NOMA and grant-based NOMA for the sidelink communication.

Aspect 36 is the method of any of aspects 30 to 35, further including receiving a PSFCH based on at least one of the transmission or the retransmission of the TB, where the PSFCH is received based on grant-free NOMA for the sidelink communication, and the PSFCH is received in a PRB carrying a second PSFCH.

Aspect 37 is the method of aspect 36, where the PSFCH received by the UE is separated from the second PSFCH in at least one of a power domain or a coding domain.

Aspect 38 is the method of any of aspects 36 and 37, further including receiving an indication of a set of PRBs assigned for the grant-free NOMA, where at least one PRB of the set of PRB is associated with more than one slot of a PSSCH.

Aspect 39 is the method of any of aspects 36 to 38, where the PSFCH is separated from the second PSFCH based on at least one of a source ID, a destination ID, a zone ID, a data priority, a QoS, a NOMA ID for determining the PRB, one or more DMRS parameters for a PSCCH or a PSSCH, a RV index, a number of CBGs or CBs, or a CRC of the PSCCH or the PSSCH.

Aspect 40 is the method of any of aspects 36 to 39, further including obtaining an indication of a timer associated with the PSFCH, where the PSFCH is received in a subsequent available PSFCH resource after an expiration of the timer.

Aspect 41 is the method of aspect 40, where the indication of the timer is obtained based on a function or a table for a number of UEs of the set of UEs.

Aspect 42 is the method of any of aspects 40 and 41, further including receiving a maximum number of UEs in the set of UEs, where the indication of the timer is obtained based on the maximum number of UEs in the set of UEs.

Aspect 43 is the method of aspect 42, where the maximum number of UEs in the set of UEs is configured per RP.

Aspect 44 is the method of any of aspects 30 to 43, further including transmitting SCI-1 or SCI-2 indicating that the transmission of the TB is associated with the grant-free NOMA.

Aspect 45 is an apparatus for wireless communication including at least one processor coupled to a memory and configured to implement any of aspects 30 to 44, further including a transceiver coupled to the at least one processor.

Aspect 46 is an apparatus for wireless communication including means for implementing any of aspects 30 to 44.

Aspect 47 is a non-transitory computer-readable medium storing computer executable code, where the code when executed by a processor causes the processor to implement any of aspects 30 to 44.

Aspect 48 is a method of wireless communication at a receiving UE, including receiving a TB from a first UE via a first transmission occasion configured for a set of UEs including the first UE, the first transmission occasion being associated with grant-free NOMA for sidelink communication and receiving a retransmission of the TB from the first UE via a first retransmission occasion based on receiving a NACK in response to transmitting the TB, the first retransmission occasion being configured for a subset of UEs that received the NACK.

Aspect 49 is the method of aspect 48, further including obtaining at least one configuration for performing the retransmission of the TB.

Aspect 50 is the method of aspect 49, where the at least one configuration includes a power configuration associated with the retransmission of the TB, where the power configuration is based on the subset of UEs.

Aspect 51 is the method of any of aspects 49 and 50, where the at least one configuration includes a DMRS configuration associated with the retransmission of the TB, where the DMRS configuration is based on the subset of UEs.

Aspect 52 is the method of any of aspects 49 to 51, further including receiving an indication of an access probability of the first UE from a network node, where the first UE is selected in the set of UEs to perform the transmission of the TB and the subset of UEs to perform the retransmission of the TB based on the access probability of the UE.

Aspect 53 is the method of any of aspects 48 to 52, further including receiving an indication to switch between the grant-free NOMA and grant-based NOMA for the sidelink communication.

Aspect 54 is the method of any of aspects 48 to 53, further including transmitting a PSFCH to the first UE based on at least one of the transmission or the retransmission of the TB, where the PSFCH is transmitted based on grant-free NOMA for the sidelink communication, and the PSFCH is received in a PRB carrying a second PSFCH.

Aspect 55 is the method of aspect 54, where the PSFCH transmitted to the first UE is separated from the second PSFCH in at least one of a power domain or a coding domain.

Aspect 56 is the method of any of aspects 54 and 55, further including receiving an indication of a set of PRBs assigned for the grant-free NOMA, where at least one PRB of the set of PRB is associated with more than one slot of a PSSCH.

Aspect 57 is the method of any of aspects 54 to 56, where the PSFCH is separated from the second PSFCH based on at least one of a source ID, a destination ID, a zone ID, a data priority, a QoS, a NOMA ID for determining the PRB, one or more DMRS parameters for a PSCCH or a PSSCH, a RV index, a number of CBGs or CBs, or a CRC of the PSCCH or the PSSCH.

Aspect 58 is the method of any of aspects 54 to 57, further including transmitting an indication of a timer associated with the PSFCH, where the PSFCH is received in a subsequent available PSFCH resource after an expiration of the timer.

Aspect 59 is the method of aspect 58, where the indication of the timer is obtained based on a function or a table for a number of UEs of the set of UEs.

Aspect 60 is the method of any of aspects 58 and 59, further including transmitting a maximum number of UEs in the set of UEs, where the indication of the timer is obtained based on the maximum number of UEs in the set of UEs.

Aspect 61 is the method of aspect 60, where the maximum number of UEs in the set of UEs is configured per RP.

Aspect 62 is the method of any of aspects 48 to 61, further including receiving SCI-1 or SCI-2 indicating that the transmission of the TB is associated with the grant-free NOMA.

Aspect 63 is an apparatus for wireless communication including at least one processor coupled to a memory and configured to implement any of aspects 48 to 62, further including a transceiver coupled to the at least one processor.

Aspect 64 is an apparatus for wireless communication including means for implementing any of aspects 48 to 62.

Aspect 65 is a non-transitory computer-readable medium storing computer executable code, where the code when executed by a processor causes the processor to implement any of aspects 48 to 62.

What is claimed is:

1. An apparatus for wireless communication at a user equipment (UE), comprising:
a memory; and
at least one processor coupled to the memory and, based at least in part on information stored in the memory, the at least one processor is configured to:
obtain at least one configuration of a set of resource pools (RPs) from a network node, the set of RPs being associated with grant-free non-orthogonal multiple access (NOMA) for sidelink communication; and
transmit a sidelink transmission via a sidelink channel to at least one other UE in the set of RPs associated with the grant-free NOMA based on the at least one configuration of the set of RPs.

2. The apparatus of claim 1, wherein the at least one configuration of the set of RPs includes a set of frequency domain orthogonal cover codes (FD-OCCs) and demodulation reference signal (DMRS) configuration identifiers (IDs) associated with at least one of a physical sidelink control channel (PSCCH) or a physical sidelink shared channel (PSSCH),
wherein the sidelink channel includes at least one of the PSCCH or the PSSCH.

3. The apparatus of claim 1, wherein the at least one configuration of the set of RPs indicates at least one sub-RP assigned for the grant-free NOMA for the sidelink communication.

4. The apparatus of claim 1, wherein the at least one configuration of the set of RPs includes dedicated configured grants shared by a plurality of UEs including the UE to perform grant-free sidelink communication.

5. The apparatus of claim 1, wherein the at least one processor is further configured to:
receive an instruction to activate or deactivate the NOMA for the sidelink communication based on at least one of a cast type, a data priority, or a quality of service (QoS).

6. The apparatus of claim 5, wherein the instruction to activate or deactivate the NOMA is received via at least one of a physical layer (L1) signal, a media access control (MAC) layer (L2) signal, or a radio resource control (RRC) layer (L3) signal.

7. The apparatus of claim 5, wherein the instruction to activate or deactivate the NOMA includes an indication of a timer, and the grant-free NOMA is activated or deactivated until an expiration of the timer.

8. The apparatus of claim 1, wherein the at least one processor is further configured to:
select a power configuration associated with one or more of at least one physical sidelink control channel (PSCCH) or at least one physical sidelink shared channel (PSSCH) on the set of RPs, wherein the power configuration is selected from a set of applicable power configurations.

9. The apparatus of claim 8, wherein the power configuration is selected based on at least one of a source identifier (ID), a destination ID, a zone ID, a data priority, a quality of service (QoS), a PSCCH cyclic redundancy check (CRC), one or more configured IDs for randomization, or a cast type.

10. The apparatus of claim 1, wherein the at least one processor is further configured to:
select a demodulation reference signal (DMRS) configuration associated with one or more or at least one physical sidelink control channel (PSCCH) or at least one physical sidelink shared channel (PSSCH) on the set of RPs, wherein the DMRS configuration is selected from a set of applicable DMRS configurations.

11. The apparatus of claim 10, wherein the DMRS configuration is selected based on at least one of a source identifier (ID), a destination ID, a zone ID, a data priority, a quality of service (QoS), a cyclic redundancy check (CRC) of sidelink control information (SCI) type 1 (SCI-1), one or more configured IDs for randomization, or a cast type.

12. The apparatus of claim 10, wherein the DMRS configuration includes a DMRS scrambling ID determined based on at least one of a source identifier (ID), a destination ID, a zone ID, a data priority, a quality of service (QoS), a cyclic redundancy check (CRC) of sidelink control information (SCI) type 1 (SCI-1), one or more configured IDs for randomization, or a cast type.

13. The apparatus of claim 1, further comprising at least one of a transceiver or an antenna coupled to the at least one processor, wherein the at least one processor is further configured to:
receive a power configuration or a demodulation reference signal (DMRS) configuration associated with at least one physical sidelink control channel (PSCCH) or at least one physical sidelink shared channel (PSSCH) on the set of RPs.

14. The apparatus of claim 1, wherein the at least one configuration of the set of RPs includes a set of frequency domain orthogonal cover codes (FD-OCC) associated with a physical sidelink control channel (PSCCH), and an oversampling factor is applied to the set of FD-OCC.

15. An apparatus for wireless communication at a network node, comprising:
a memory; and
at least one processor coupled to the memory and, based at least in part on information stored in the memory, the at least one processor is configured to:
transmit at least one configuration of a set of resource pools (RPs) for a plurality of UEs including a first UE and a second UE, the set of RPs being associated with grant-free non-orthogonal multiple access (NOMA) for sidelink communication between the plurality of UEs; and
transmit an instruction to activate or deactivate the NOMA for the sidelink communication for the plurality of UEs,
wherein a sidelink transmission is communicated between the first UE and the second UE via a sidelink channel in the set of RPs associated with the grant-free NOMA based on the at least one configuration of the sidelink channel.

16. The apparatus of claim 15, wherein the at least one configuration of the set of RPs includes a set of frequency domain orthogonal cover codes (FD-OCC s) and demodulation reference signal (DMRS) configuration identifiers (IDs) associated with at least one of a physical sidelink control channel (PSCCH) or a physical sidelink shared channel (PSSCH),
wherein the sidelink channel includes at least one of the PSCCH or the PSSCH.

17. The apparatus of claim 15, wherein the at least one configuration of the set of RPs indicates at least one sub-RP assigned for the grant-free NOMA for the sidelink communication.

18. The apparatus of claim 15, wherein the at least one configuration of the set of RPs includes dedicated configured grants shared by the plurality of UEs to perform grant-free sidelink communication.

19. The apparatus of claim 15, wherein the instruction to activate or deactivate the NOMA for the sidelink communication is based on at least one of a cast type, a data priority, or a quality of service (QoS).

20. The apparatus of claim 19, wherein the instruction to activate or deactivate the NOMA is transmitted via at least one of a physical layer (L1) signal, a media access control (MAC) layer (L2) signal, or a radio resource control (RRC) layer (L3) signal.

21. The apparatus of claim 19, wherein the instruction to activate or deactivate the NOMA includes an indication of a timer, and the grant-free NOMA is activated or deactivated until an expiration of the timer.

22. The apparatus of claim 15, further comprising at least one of a transceiver or an antenna coupled to the at least one processor, wherein the at least one processor is further configured to:
transmit a power configuration or a demodulation reference signal (DMRS) configuration associated with at least one physical sidelink control channel (PSCCH) or at least one physical sidelink shared channel (PSSCH) on the set of RPs.

23. The apparatus of claim 15, wherein the at least one configuration of the set of RPs includes a set of frequency domain orthogonal cover codes (FD-OCC) associated with a physical sidelink control channel (PSCCH), and an oversampling factor is applied to the set of FD-OCC.

24. A method of wireless communication at a user equipment (UE), comprising:
obtaining at least one configuration of a set of resource pools (RPs) from a network node, the set of RPs being associated with grant-free non-orthogonal multiple access (NOMA) for sidelink communication; and
transmitting a sidelink transmission via a sidelink channel to at least one other UE in the set of RPs associated with the grant-free NOMA based on the at least one configuration of the set of RPs.

25. The method of claim 24, further comprising:
receiving an instruction to activate or deactivate the NOMA for the sidelink communication based on at least one of a cast type, a data priority, or a quality of service (QoS).

26. The method of claim 24, further comprising:
selecting a power configuration associated with one or more of at least one physical sidelink control channel (PSCCH) or at least one physical sidelink shared channel (PSSCH) on the set of RPs, wherein the power configuration is selected from a set of applicable power configurations.

27. The method of claim 24, further comprising:
selecting a demodulation reference signal (DMRS) configuration associated with one or more or at least one physical sidelink control channel (PSCCH) or at least one physical sidelink shared channel (PSSCH) on the set of RPs, wherein the DMRS configuration is selected from a set of applicable DMRS configurations.

28. The method of claim 24, further comprising:
receiving a power configuration or a demodulation reference signal (DMRS) configuration associated with at least one physical sidelink control channel (PSCCH) or at least one physical sidelink shared channel (PSSCH) on the set of RPs.

29. A method of wireless communication at a network node, comprising:
transmitting at least one configuration of a set of resource pools (RPs) for a plurality of UEs including a first UE and a second UE, the set of RPs being associated with grant-free non-orthogonal multiple access (NOMA) for sidelink communication between the plurality of UEs; and
transmitting an instruction to activate or deactivate the NOMA for the sidelink communication for the plurality of UEs,
wherein a sidelink transmission is communicated between the first UE and the second UE via a sidelink channel in the set of RPs associated with the grant-free NOMA based on the at least one configuration of the sidelink channel.

30. The method of claim 29, further comprising:
transmitting a power configuration or a demodulation reference signal (DMRS) configuration associated with at least one physical sidelink control channel (PSCCH) or at least one physical sidelink shared channel (PSSCH) on the set of RPs.
